(19) United States
(12) Patent Application Publication
(10) Pub. No.: US 2026/0140475 A1
(43) Pub. Date: May 21, 2026

(54) CARTRIDGE INCLUDING CARTRIDGE FRAME, FIRST TO THIRD ELECTRODES POSITIONED AT CARTRIDGE FRAME, AND CARTRIDGE MEMORY MOVABLE RELATIVE TO CARTRIDGE FRAME

(71) Applicant: BROTHER KOGYO KABUSHIKI KAISHA, Nagoya (JP)

(72) Inventor: Nao ITABASHI, Nagoya (JP)

(73) Assignee: BROTHER KOGYO KABUSHIKI KAISHA, Nagoya (JP)

(21) Appl. No.: 19/421,853

(22) Filed: Dec. 16, 2025

Related U.S. Application Data
(63) Continuation of application No. PCT/JP2024/023134, filed on Jun. 26, 2024.

(30) Foreign Application Priority Data
Jun. 27, 2023 (JP) 2023-104961
Jun. 27, 2023 (JP) 2023-104962
Jun. 27, 2023 (JP) 2023-104963

(51) Int. Cl. G03G 21/18; G03G 21/16

(52) U.S. Cl. CPC G03G 21/1885; G03G 21/1647; G03G 21/1652; G03G 21/1814; G03G 21/1871; G03G 2221/1823; G03G 2221/1884

(57) ABSTRACT

A cartridge attachable to and detachable from a drawer movable in a first direction includes: a photosensitive drum including a drum shaft extending in a second direction; a developing roller including a developing shaft extending in the second direction; a cartridge frame supporting the photosensitive drum and the developing roller; first through third electrodes; and a cartridge memory movable in the second direction relative to the cartridge frame. The first electrode is positioned at one end portion of the cartridge frame in the second direction. The second electrode is positioned at one end portion of the cartridge frame in the first direction. The third electrode is positioned at an other end portion of the cartridge frame in the first direction. The cartridge memory is positioned at the one end portion of the cartridge frame in the second direction. The cartridge memory includes a memory electrode facing in the second direction.

### REFERENCE TO RELATED APPLICATIONS

This is a by-pass continuation application of International Application No. PCT/JP2024/023134 filed on Jun. 26, 2024 which claims priorities from Japanese Patent Application No. 2023-104961 filed on Jun. 27, 2023, Japanese Patent Application No. 2023-104962 filed on Jun. 27, 2023, and Japanese Patent Application No. 2023-104963 filed on Jun. 27, 2023. The entire contents of the International Application and the priority applications are incorporated herein by reference.

### BACKGROUND ART

There has been known an image forming apparatus including a main housing, a drawer movable between an interior of the main housing and an exterior of the main housing, and cartridges attachable to and detachable from the drawer. In this technology, each of the cartridges includes a photosensitive drum and a developing roller. Each of the cartridges also includes a memory on a side surface of the cartridge. The memory includes a memory electrode facing in an axial direction of the photosensitive drum.

### SUMMARY

Since the memory of the cartridge described above is exposed to the outside, an excessive load may be imparted on the memory when the memory is touched, for example.

In view of the foregoing, it is an object of the present disclosure to reduce a load to be applied to a memory of a cartridge.

Further, in a case where the cartridge is moved significantly in the axial direction of the photosensitive drum during the movement of the drawer to which the cartridge is attached into the main housing, the electrodes in the cartridge may contact the drawer or the main housing.

It is another object of the present disclosure to restrict contact of an electrode of a cartridge with a drawer or a main housing.

Still further, there is a possibility that the side surface of the cartridge contacts the drawer during the attachment of the cartridge to the drawer, which may lead to contact of the electrodes on the side surface of the cartridge with the drawer.

It is still another object of the present disclosure to restrict contact of a side surface of a cartridge with a drawer during the attachment of the cartridge to the drawer.

In order to attain the above and other objects, the present disclosure provides a cartridge attachable to and detachable from a drawer movable in a first direction relative to a main housing of an image forming apparatus between a first position in which the drawer is accommodated in the main housing and a second position in which at least a part of the drawer is positioned outside the main housing. The cartridge includes: a photosensitive drum; a developing roller; a cartridge frame; a first electrode; a second electrode; a third electrode; and a cartridge memory. The photosensitive drum includes a drum shaft extending in a second direction crossing the first direction. The developing roller includes a developing shaft extending in the second direction. The cartridge frame supports both the photosensitive drum and the developing roller. The first electrode is positioned at one end portion of the cartridge frame in the second direction. The second electrode is positioned at one end portion of the cartridge frame in the first direction. The third electrode is positioned at an other end portion of the cartridge frame in the first direction. The cartridge memory is positioned at the one end portion of the cartridge frame in the second direction. The cartridge memory is movable in the second direction relative to the cartridge frame. The cartridge memory includes a memory electrode facing in the second direction.

In the above structure, the cartridge memory is movable in the second direction relative to the cartridge frame, whereby a load to be imparted on the cartridge memory can be reduced.

### BRIEF DESCRIPTION OF DRAWINGS

FIG. 1 is a diagram illustrating an image forming apparatus.

FIG. 2A is a perspective view of the image forming apparatus, and illustrating a state where a drawer is in a first position.

FIG. 2B is a perspective view of the image forming apparatus, and illustrating a state where the drawer is in a second position.

FIG. 3A is a perspective view of a cartridge.

FIG. 3B is another perspective view of the cartridge.

FIG. 4A is an exploded perspective view of the cartridge.

FIG. 4B is a diagram illustrating a cartridge memory.

FIG. 5A is a cross-sectional view of the cartridge, and illustrating a state where a developing frame is in a developing position.

FIG. 5B is a cross-sectional view of the cartridge, and illustrating a state where the developing frame is in a separation position.

FIGS. 6A and 6B are perspective views illustrating the movement of the cartridge memory.

FIG. 7A is a perspective view of a first side cover and a cartridge electrode.

FIG. 7B is a perspective view of the cartridge electrode.

FIG. 8 is a side view of the drawer and the cartridges.

FIG. 9 is a perspective view of the drawer and the cartridges.

FIG. 10A is an enlarged perspective view illustrating an area in the vicinity of one of cartridge guides of the drawer, and illustrating a state where the cartridge is attached to the drawer.

FIG. 10B is an enlarged perspective view illustrating the area in the vicinity of one of the cartridge guides of the drawer, and illustrating a state where the cartridge is not attached to the drawer.

FIG. 11 is a perspective view of a main housing, and illustrating a state where a cover is in an open position.

FIG. 12A is a perspective view of the main housing and particularly illustrating a guide groove.

FIG. 12B is an enlarged perspective view illustrating an area in the vicinity of an opening of the guide groove.

FIG. 13 is a diagram illustrating a state where the drawer to which the cartridge is attached is allowed to be moved in a first direction relative to the main housing.

FIG. 14 is a diagram illustrating a state where the drawer is in the first position and the cartridge is pressed by a drum joint and a developing joint.

FIG. 15 is a diagram illustrating the drawer and the cartridges, and particularly illustrating pressing projections, drum couplings, and developing couplings.

FIGS. 16A through 16C are enlarged views of one of the pressing projections and a part of a second main wall.

FIG. 17A is a partial perspective view of the cartridge, and particularly illustrating an inclined surface of the cartridge.

FIG. 17B is a perspective view of the main housing, and particularly illustrating protrusions of the main housing.

FIGS. 18A through 18C are diagrams illustrating the function of the cartridge guide during an attachment of the cartridge to the drawer.

FIGS. 19A through 19C are diagrams illustrating the function of the inclined surface of the cartridge.

FIGS. 20A through 20C are diagrams illustrating the function of the cartridge guide during a detachment of the cartridge from the drawer.

FIGS. 21A through 21C are diagrams illustrating an image forming apparatus.

FIGS. 22A through 21C are diagrams illustrating the image forming apparatus.

FIGS. 23A and 23B are diagrams illustrating a cartridge and a drawer.

FIGS. 24A and 24B are diagrams illustrating the cartridge and the drawer.

FIG. 25 is a perspective view of a drawer.

FIGS. 26A and 26B are diagrams illustrating the cartridge, the drawer, and the main housing.

FIGS. 27A and 27B are perspective views illustrating the movement of a cartridge memory.

FIG. 27C is a diagram illustrating the cartridge memory.

FIG. 28 is a diagram illustrating cartridges.

### DESCRIPTION

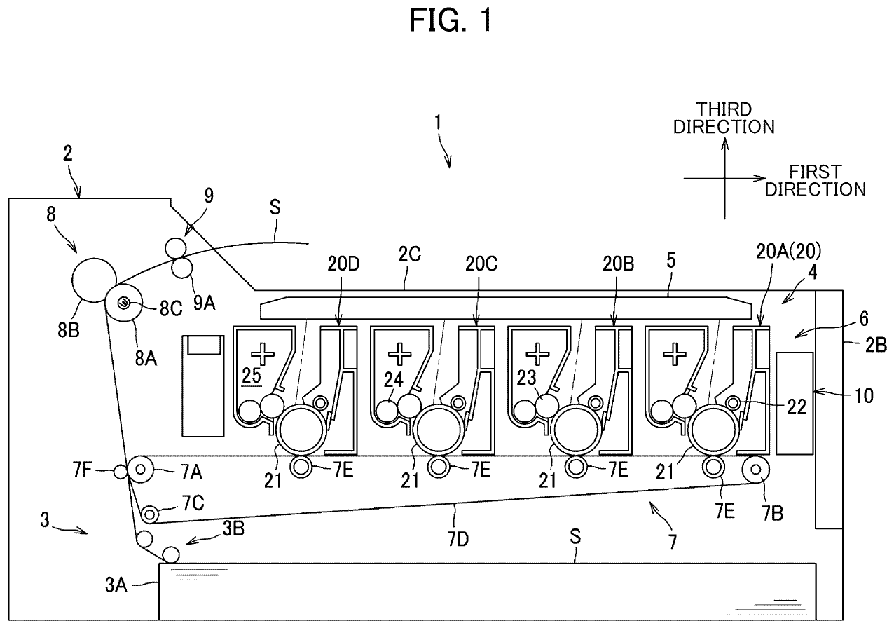

Hereinafter, an embodiment of the present disclosure will be described while referring to the accompanying drawings. As illustrated in FIG. 1, an image forming apparatus 1 is a color laser printer. The image forming apparatus 1 includes a main housing 2, a sheet feeding unit 3, an image forming unit 4, and a sheet discharging unit 9. In the drawings, arrows are used to indicate a first direction, a second direction, and a third direction. In these drawings, each arrow points to one side in the corresponding direction. Specifically, a leading side of each arrow represents one side in the corresponding direction, and a trailing side of each arrow represents the other side in the corresponding direction.

Also, an end portion of a component at one side in each direction will be referred to as “one end portion of the component in the corresponding direction”, and an end portion of the component at the other side in each direction will be referred to as “the other end portion of the component in the corresponding direction” as appropriate.

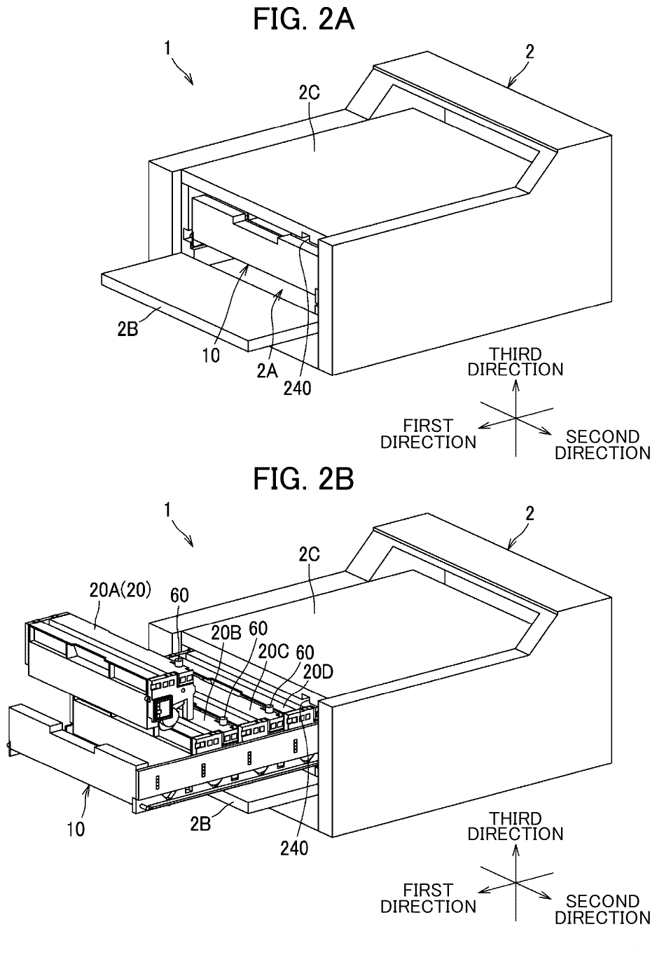

The main housing 2 has a main opening 2A (see FIG. 2A), and includes a cover 2B and a discharge tray 2C. The main opening 2A and the cover 2B are positioned at one end portion of the main housing 2 in the first direction. The cover 2B is configured to open and close the main opening 2A. The cover 2B is movable between a closed position (see FIG. 1) in which the cover 2B closes the main opening 2A and an open position (see FIGS. 2A and 2B) in which the cover 2B opens the main opening 2A. Specifically, the cover 2B is pivotally movable between the closed position and the open position.

The sheet feeding unit 3 includes a sheet tray 3A and a feeding mechanism 3B. The sheet tray 3A is configured to accommodate one or more sheets S. The sheet tray 3A is mountable in and removable from the main housing 2. The feeding mechanism 3B is configured to feed the one or more sheets S in the sheet tray 3A to the image forming unit 4.

The image forming unit 4 includes an exposure unit 5, a drum unit 6, a transfer unit 7, and a fixing unit 8. The exposure unit 5 is configured to emit laser beams indicated by dashed lines in FIG. 1 onto charged surfaces of photosensitive drums 21 to expose the surfaces of the photosensitive drums 21 to light.

The drum unit 6 includes a drawer 10 and four cartridges 20. The drawer 10 is configured to support the cartridges 20. The cartridges 20 include a first cartridge 20A, a second cartridge 20B, a third cartridge 20C, and a fourth cartridge 20D.

Each of the first cartridge 20A, the second cartridge 20B, the third cartridge 20C, and the fourth cartridge 20D is attachable to and detachable from the drawer 10. When attached to the drawer 10, the first cartridge 20A, the second cartridge 20B, the third cartridge 20C, and the fourth cartridge 20D are arranged in the first direction. In the present embodiment, the cartridges 20 are arranged in order of the first cartridge 20A, the second cartridge 20B, the third cartridge 20C, and the fourth cartridge 20D from one end portion of the drawer 10 in the first direction to the other end portion of the drawer 10 in the first direction.

Each of the cartridges 20 includes the photosensitive drum 21, a charging roller 22, a developing roller 23, a supply roller 24, and a toner accommodating portion 25. For example, the toner accommodating portion 25 of the first cartridge 20A accommodates black toner, the toner accommodating portion 25 of the second cartridge 20B accommodates cyan toner, the toner accommodating portion 25 of the third cartridge 20C accommodates magenta toner, and the toner accommodating portion 25 of the fourth cartridge 20D accommodates yellow toner.

The transfer unit 7 includes a first roller 7A, a second roller 7B, a third roller 7C, an intermediate transfer belt 7D, four primary transfer rollers 7E, and a secondary transfer roller 7F. The intermediate transfer belt 7D is an endless belt looped over the first roller 7A, the second roller 7B, and the third roller 7C. The primary transfer rollers 7E nip, in cooperation with the corresponding photosensitive drums 21, the intermediate transfer belt 7D between the primary transfer rollers 7E and the corresponding photosensitive drums 21. The secondary transfer roller 7F nips, in cooperation with the first roller 7A, the intermediate transfer belt 7D between the secondary transfer roller 7F and the first roller 7A.

The fixing unit 8 includes a heating roller 8A and a pressure roller 8B. A heater 8C is arranged inside the heating roller 8A. The pressure roller 8B is configured to convey the sheet S in cooperation with the heating roller 8A.

The image forming unit 4 charges the surfaces of the photosensitive drums 21 using the corresponding charging rollers 22, and exposes the surfaces of the photosensitive drums 21 to light using the exposure unit 5. This process forms electrostatic latent images on the surfaces of the photosensitive drums 21. The image forming unit 4 supplies toner in the toner accommodating portions 25 to the corresponding developing rollers 23 via the supply rollers 24, and then supplies the toner from the developing rollers 23 to the corresponding photosensitive drums 21. As a result, toner images are formed on the surfaces of the photosensitive drums 21.

Subsequently, the image forming unit 4 transfers the toner images which have been formed on the surfaces of the photosensitive drums 21 onto the intermediate transfer belt 7D via the corresponding primary transfer rollers 7E. Then, the image forming unit 4 transfers the toner images which have been transferred onto the intermediate transfer belt 7D onto the sheet S using the secondary transfer roller 7F. The image forming unit 4 conveys the sheet S between the heating roller 8A and the pressure roller 8B to fix the toner images that have been transferred onto the sheet S to the sheet S.

The sheet discharging unit 9 includes discharging rollers 9A. The discharging rollers 9A are configured to discharge the sheets S conveyed from the image forming unit 4 onto the discharge tray 2C.

As illustrated in FIGS. 2A and 2B, in a state where the cover 2B is in the open position, the drawer 10 is movable in the first direction relative to the main housing 2 of the image forming apparatus 1 through the main opening 2A. The drawer 10 is movable in the first direction between a first position illustrated in FIG. 2A and a second position illustrated in FIG. 2B. The first position is a position in which the drawer 10 is accommodated in the main housing 2. The second position is a position in which at least a part of the drawer 10 is positioned outside the main housing 2. In the present embodiment, the cartridges 20 are attachable to and detachable from the drawer 10 in a state where the drawer 10 is in the second position. Further, the drawer 10 is mountable in and removable from the main housing 2.

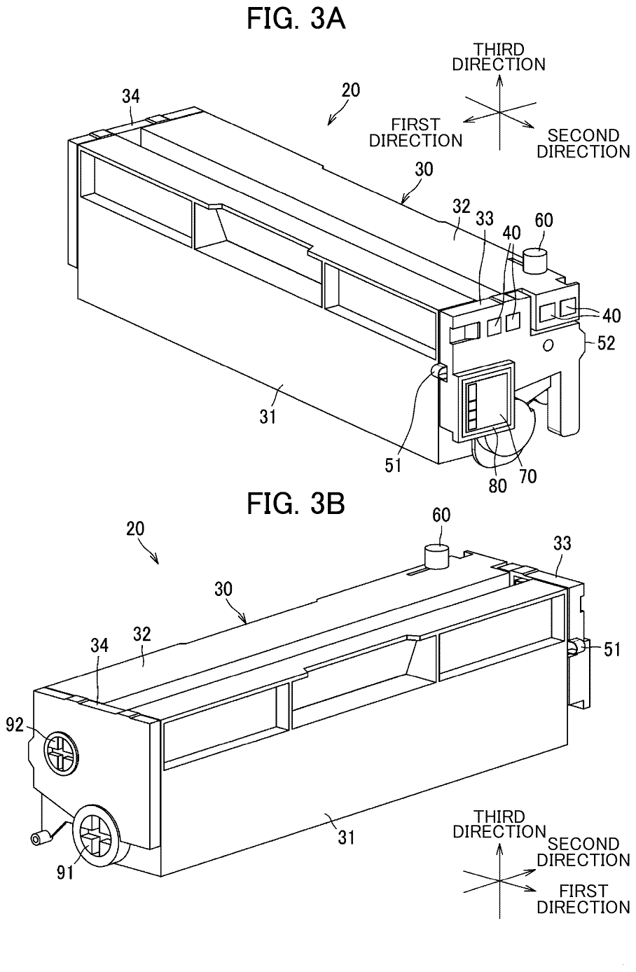

As illustrated in FIGS. 3A and 3B, each of the cartridges 20 (i.e., the first through fourth cartridges 20A through 20D) further includes a cartridge frame 30, first electrodes 40, a second electrode 51, a third electrode 52, a boss 60, a cartridge memory 70, a memory holder 80, a drum coupling 91, and a developing coupling 92.

The first electrodes 40, the cartridge memory 70, and the memory holder 80 are positioned at one end portion of the cartridge frame 30 in the second direction. The second direction is a direction crossing the first direction. In the present embodiment, the second direction is a direction orthogonal to the first direction. The second electrode 51 is positioned at one end portion of the cartridge frame 30 in the first direction. The third electrode 52 is positioned at the other end portion of the cartridge frame 30 in the first direction. The second electrode 51 and the third electrode 52 are positioned at the one end portion of the cartridge frame 30 in the second direction.

The boss 60 protrudes in the third direction. The third direction is a direction crossing both the first direction and the second direction. In the present embodiment, the third direction is a direction orthogonal to both the first direction and the second direction. The boss 60 is positioned at one end portion of the cartridge frame 30 in the third direction. The boss 60 is positioned at the other end portion of the cartridge frame 30 in the first direction. The boss 60 is positioned at the one end portion of the cartridge frame 30 in the second direction. The boss 60 has a columnar shape.

The drum coupling 91 and the developing coupling 92 are positioned at the other end portion of the cartridge frame 30 in the second direction. The drum coupling 91 is a member configured to transmit a drive force to the photosensitive drum 21, and the developing coupling 92 is a member configured to transmit a drive force to the developing roller 23. The photosensitive drum 21 rotates when a rotational drive force is inputted from the main housing 2 to the drum coupling 91. The developing roller 23 rotates when a rotational drive force is inputted from the main housing 2 to the developing coupling 92.

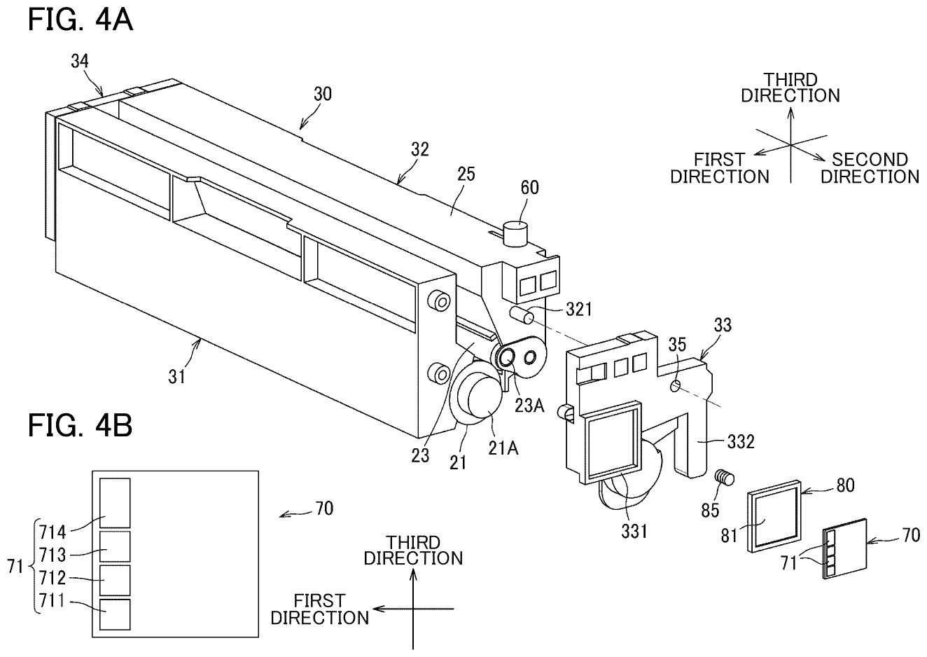

As illustrated in FIG. 4A, the cartridge frame 30 supports the photosensitive drum 21 and the developing roller 23. The cartridge frame 30 includes a drum frame 31, a developing frame 32, a first side cover 33, and a second side cover 34. The first side cover 33 is an example of the “side cover”.

The drum frame 31 supports the photosensitive drum 21. The photosensitive drum 21 includes a drum shaft 21A extending in the second direction. The drum frame 31 supports the drum shaft 21A so that the drum shaft 21A is rotatable. The drum frame 31 also supports the charging roller 22 so that the charging roller 22 is rotatable.

The developing frame 32 supports the developing roller 23. The developing roller 23 includes a developing shaft 23A extending in the second direction. The developing frame 32 supports the developing shaft 23A so that the developing shaft 23A is rotatable. The developing frame 32 also supports the supply roller 24 so that the supply roller 24 is rotatable. The toner accommodating portion 25 is disposed in the developing frame 32.

The first side cover 33 and the second side cover 34 support the drum frame 31 and the developing frame 32. The first side cover 33 is positioned at one end portion of the drum frame 31 in the second direction and at one end portion of the developing frame 32 in the second direction. Specifically, the first side cover 33 supports both the one end portion of the drum frame 31 in the second direction and the one end portion of the developing frame 32 in the second direction. The second side cover 34 is positioned at the other end portion of the drum frame 31 in the second direction and at the other end portion of the developing frame 32 in the second direction. Specifically, the second side cover 34 supports both the other end portion of the drum frame 31 in the second direction and the other end portion of the developing frame 32 in the second direction.

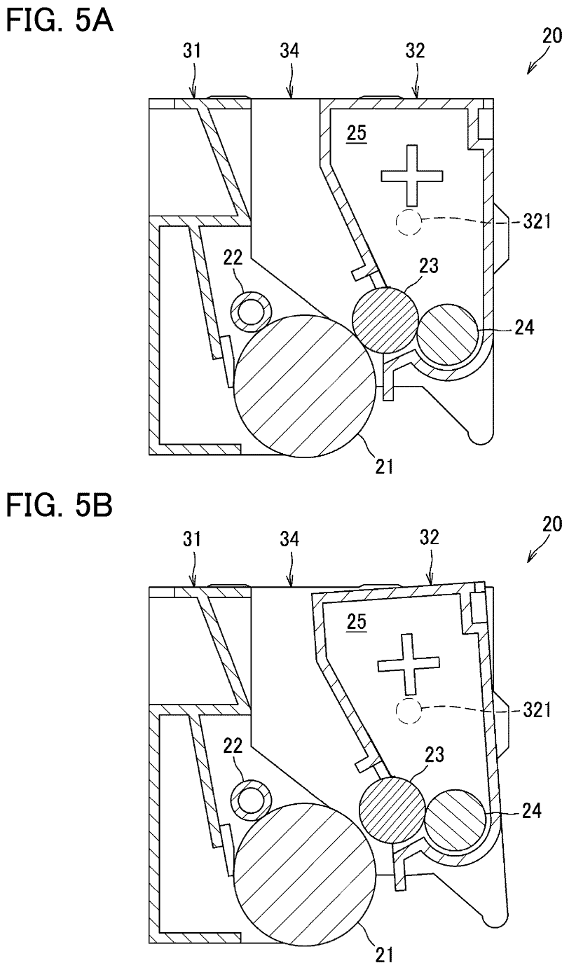

The developing frame 32 includes a pivot shaft 321 at each of the one end portion of the developing frame 32 in the second direction and the other end portion of the developing frame 32 in the second direction. The pivot shafts 321 protrude in the second direction. The developing frame 32 is pivotally movable about the pivot shafts 321 relative to the drum frame 31 between a developing position illustrated in FIG. 5A and a separation position illustrated in FIG. 5B. The developing position is a position in which the developing roller 23 supplies toner to the photosensitive drum 21. In the present embodiment, the developing roller 23 is in contact with the photosensitive drum 21 in a state where the developing frame 32 is in the developing position. The separation position is a position in which the developing roller 23 is positioned farther away from the photosensitive drum 21 than in the developing position.

As illustrated in FIG. 4A, the pivot shafts 321 of the developing frame 32 are respectively supported by the first side cover 33 and the second side cover 34 so that the developing frame 32 is pivotally movable. Specifically, each of the first side cover 33 and the second side cover 34 has a hole 35. The pivot shafts 321 of the developing frame 32 are fitted in the respective holes 35 so that the developing frame 32 is pivotally movable. The first side cover 33 and the second side cover 34 are fixed to the drum frame 31.

The cartridge memory 70 is a memory storing information related to the cartridge 20, for example, identification information such as the serial number, and information related to the service life of the cartridge 20. As an example, the cartridge memory 70 is an IC chip. The cartridge memory 70 includes memory electrodes 71. The memory electrodes 71 face in the second direction. Specifically, the memory electrodes 71 face the one side in the second direction.

As illustrated in FIG. 4B, the memory electrodes 71 include a first memory electrode 711, a second memory electrode 712, a third memory electrode 713, and a fourth memory electrode 714. The first memory electrode 711, the second memory electrode 712, the third memory electrode 713, and the fourth memory electrode 714 have rectangular shapes. The first memory electrode 711, the second memory electrode 712, the third memory electrode 713, and the fourth memory electrode 714 are arranged in the third direction.

Specifically, the second memory electrode 712 is positioned closer to the one end portion of the cartridge frame 30 in the third direction than the first memory electrode 711 is to the one end portion of the cartridge frame 30 in the third direction. The third memory electrode 713 is positioned closer to the one end portion of the cartridge frame 30 in the third direction than the second memory electrode 712 is to the one end portion of the cartridge frame 30 in the third direction. The fourth memory electrode 714 is positioned closer to the one end portion of the cartridge frame 30 in the third direction than the third memory electrode 713 is to the one end portion of the cartridge frame 30 in the third direction. In other words, the memory electrodes 71 are arranged in order of the first memory electrode 711, the second memory electrode 712, the third memory electrode 713, and the fourth memory electrode 714 from the other end portion of the cartridge frame 30 in the third direction to the one end portion of the cartridge frame 30 in the third direction.

The fourth memory electrode 714 has a length in the third direction that is the largest among the first memory electrode 711, the second memory electrode 712, the third memory electrode 713, and the fourth memory electrode 714 of the memory electrodes 71. The first memory electrode 711, the second memory electrode 712, and the third memory electrode 713 have lengths in the third direction the same as one another. Also, the first memory electrode 711, the second memory electrode 712, the third memory electrode 713, and the fourth memory electrode 714 have lengths in the first direction the same as one another.

As illustrated in FIG. 4A, the memory holder 80 is a member that holds the cartridge memory 70. The memory holder 80 has a plate shape. The memory holder 80 includes a recess 81 having a rectangular shape. The recess 81 is open toward the one side in the second direction. The cartridge memory 70 is held by the memory holder 80 while the cartridge memory 70 is fitted in the recess 81.

The memory holder 80 has a color that corresponds to the color of the toner accommodated in the cartridge frame 30. For example, the color of the memory holder 80 for the first cartridge 20A is black, the color of the memory holder 80 for the second cartridge 20B is cyan, the color of the memory holder 80 for the third cartridge 20C is magenta, and the color of the memory holder 80 for the fourth cartridge 20D is yellow. Note that the colors of the memory holders 80 may not be respectively identical to the colors of the toner accommodated in the cartridge frames 30 provided that the colors the toner accommodated in the cartridge frames 30 of the first through fourth cartridges 20A through 20D can be recognized.

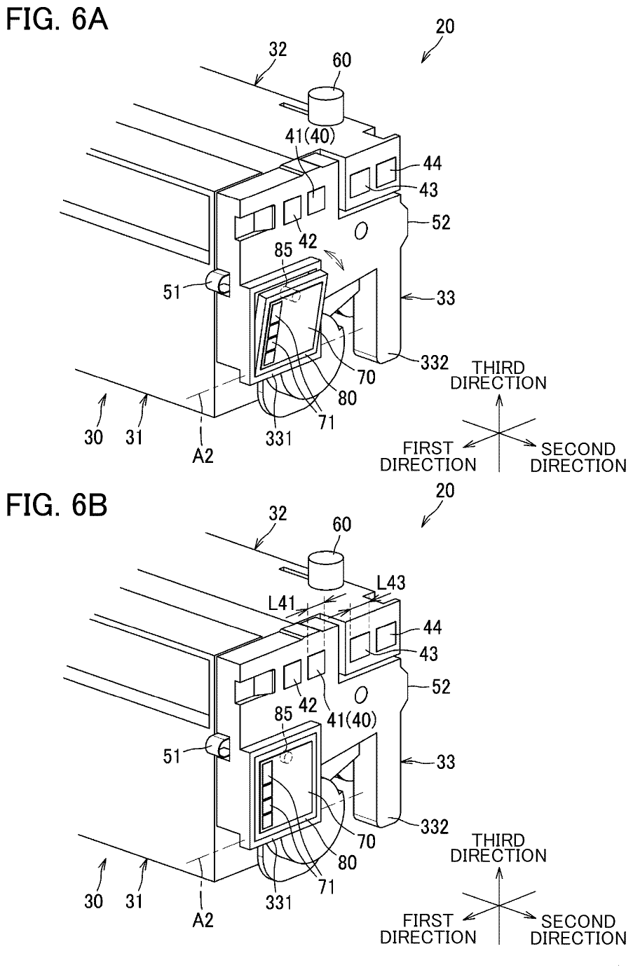

As illustrated in FIGS. 6A and 6B, the cartridge memory 70 is movable in the second direction relative to the cartridge frame 30. Specifically, the memory holder 80 that holds the cartridge memory 70 is movable in the second direction relative to the cartridge frame 30 together with the cartridge memory 70.

The cartridge frame 30 includes a holding portion 331. The holding portion 331 has a frame shape. The holding portion 331 protrudes in the second direction from one end portion of the first side cover 33 in the second direction. The memory holder 80 is configured to be received in the holding portion 331. The memory holder 80 is held by the holding portion 331 so as to be movable in the second direction.

Specifically, the memory holder 80 is pivotally movable about a second axis A2 extending in the first direction relative to the holding portion 331. The second axis A2 is positioned at the other end portion of the memory holder 80 in the third direction. The other end portion of the memory holder 80 in the third direction is pivotally movable about the second axis A2, while one end portion of the memory holder 80 in the third direction is movable in the second direction. The second axis A2 is an example of the “pivot axis”.

Each of the cartridges 20 also includes a resilient member 85. The resilient member 85 is arranged inside the frame-shaped holding portion 331 at a position between the memory holder 80 and the first side cover 33. Specifically, the resilient member 85 is positioned between the one end portion of the memory holder 80 in the third direction and the first side cover 33. In a state where the drawer 10 to which the cartridge 20 is attached is in the first position, the resilient member 85 urges the memory holder 80 in a direction toward one end portion of the main housing 2 in the second direction. Specifically, the resilient member 85 urges the one end portion of the memory holder 80 in the third direction toward the one side in the second direction. For example, the resilient member 85 is a compression coil spring.

The first electrodes 40 include a drum electrode 41, a charging electrode 42, a developing electrode 43, and a supply electrode 44. The drum electrode 41 and the charging electrode 42 are positioned at the one end portion of the drum frame 31 in the second direction. Specifically, the drum electrode 41 and the charging electrode 42 are positioned at the one end portion of the first side cover 33 in the second direction.

The drum electrode 41 is an electrode for grounding the photosensitive drum 21. The drum electrode 41 is electrically connected to the photosensitive drum 21. Specifically, the drum electrode 41 is electrically connected to the drum shaft 21A. The charging electrode 42 is an electrode for supplying voltage to the charging roller 22. The charging electrode 42 is electrically connected to the charging roller 22.

The developing electrode 43 and the supply electrode 44 are positioned at the one end portion of the developing frame 32 in the second direction. The developing electrode 43 is an electrode for supplying voltage to the developing roller 23. The developing electrode 43 is electrically connected to the developing roller 23. Specifically, the developing electrode 43 is electrically connected to the developing shaft 23A. The supply electrode 44 is an electrode for supplying voltage to the supply roller 24. The supply electrode 44 is electrically connected to the supply roller 24.

The developing electrode 43 protrudes further toward the one side in the second direction than the drum electrode 41 does. Specifically, one end face of the developing electrode 43 in the second direction is positioned further toward the one side in the second direction than one end face of the drum electrode 41 in the second direction. The one end face of the developing electrode 43 in the second direction and one end face of the supply electrode 44 in the second direction are at the same position in the second direction. The one end face of the drum electrode 41 in the second direction and one end face of the charging electrode 42 in the second direction are at the same position in the second direction.

A length L43 of the developing electrode 43 in the first direction is greater than a length L41 of the drum electrode 41 in the first direction. The length of the supply electrode 44 in the first direction is the same as the length L43 of the developing electrode 43 in the first direction. The length of the charging electrode 42 in the first direction is the same as the length L41 of the drum electrode 41 in the first direction.

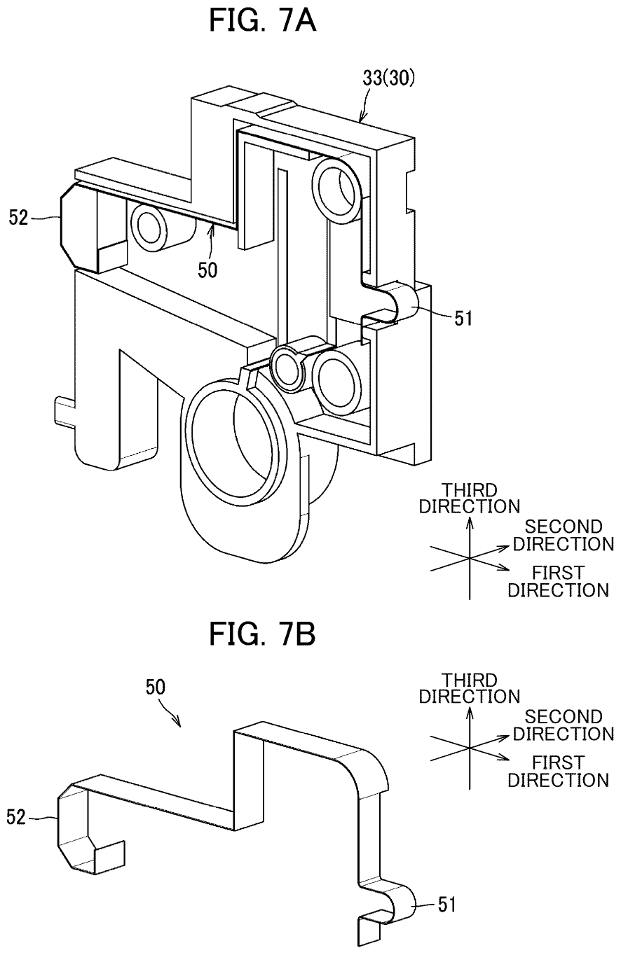

As illustrated in FIGS. 7A and 7B, the second electrode 51 and the third electrode 52 are electrically connected to each other. Specifically, each of the cartridges 20 also includes a cartridge electrode 50. The cartridge electrode 50 is positioned at the one end portion of the cartridge frame 30 in the second direction. Specifically, the cartridge electrode 50 is positioned inside the first side cover 33. The cartridge electrode 50 is held by the first side cover 33. The cartridge electrode 50 is made of a metal plate.

The second electrode 51 is one end portion of the cartridge electrode 50 in the first direction. The second electrode 51 is positioned at one end portion of the first side cover 33 in the first direction. The second electrode 51 is exposed from one end face of the first side cover 33 in the first direction. The third electrode 52 is the other end portion of the cartridge electrode 50 in the first direction. The third electrode 52 is positioned at the other end portion of the first side cover 33 in the first direction. The third electrode 52 is exposed from the other end face of the first side cover 33 in the first direction.

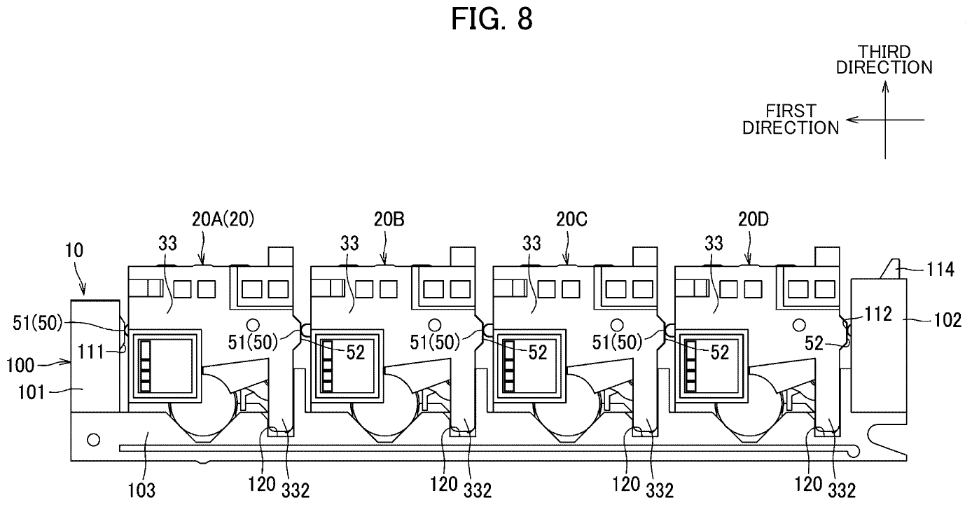

As illustrated in FIG. 8, the drawer 10 includes a drawer frame 100, a first drawer electrode 111, and a second drawer electrode 112. The drawer frame 100 is configured to support the cartridges 20. The drawer frame 100 includes a first drawer wall 101, a second drawer wall 102, and a third drawer wall 103.

The first drawer wall 101 constitutes one end portion of the drawer frame 100 in the first direction. The first drawer wall 101 extends in the second direction. The second drawer wall 102 constitutes the other end portion of the drawer frame 100 in the first direction. The second drawer wall 102 extends in the second direction. The first drawer wall 101 and the second drawer wall 102 oppose each other in the first direction.

The third drawer wall 103 is positioned at one end portion of the drawer frame 100 in the second direction and at the other end portion of the drawer frame 100 in the third direction. The third drawer wall 103 extends in the first direction. The third drawer wall 103 connects one end portion of the first drawer wall 101 in the second direction and one end portion of the second drawer wall 102 in the second direction to each other.

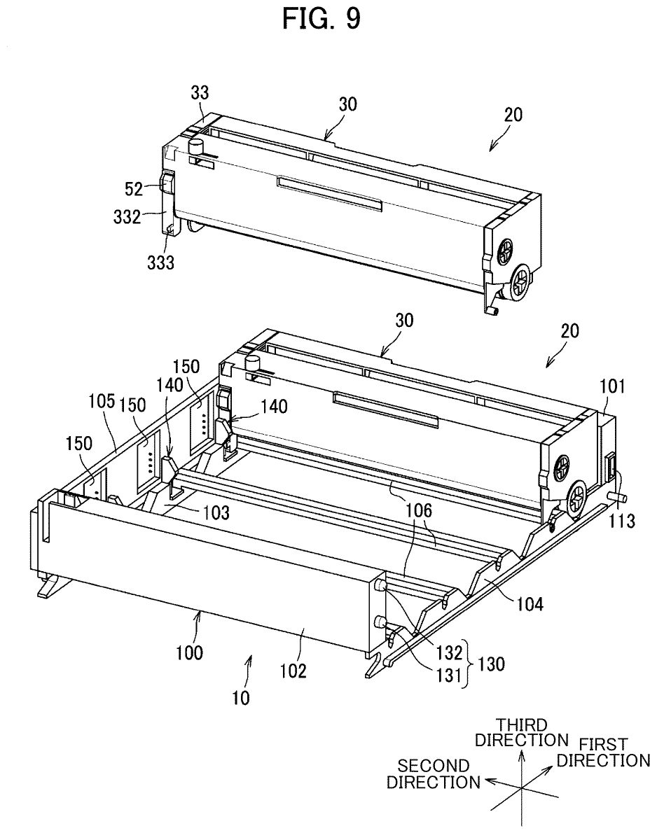

The first drawer electrode 111 is an electrode configured to be electrically connected to an electrode of the main housing 2 via a connector 113 (see FIG. 9). The first drawer electrode 111 is positioned at the one end portion of the drawer frame 100 in the first direction and at the one end portion of the drawer frame 100 in the second direction. Specifically, the first drawer electrode 111 is positioned at one end portion of the first drawer wall 101 in the second direction. A part of the first drawer electrode 111 is positioned inside the first drawer wall 101, and the remaining part of the first drawer electrode 111 is exposed from a surface of the first drawer wall 101 that is close to the second drawer wall 102 in the first direction.

The second drawer electrode 112 is an electrode configured to be electrically connected to another electrode of the main housing 2 via a lever 114 having electrical conductivity. The second drawer electrode 112 is positioned at the other end portion of the drawer frame 100 in the first direction and at the one end portion of the drawer frame 100 in the second direction. Specifically, the second drawer electrode 112 is positioned at one end portion of the second drawer wall 102 in the second direction. A part of the second drawer electrode 112 is positioned inside the second drawer wall 102, and the remaining part of the second drawer electrode 112 is exposed from a surface of the second drawer wall 102 that is close to the first drawer wall 101 in the first direction.

In a state where the first through fourth cartridges 20A through 20D are attached to the drawer 10, the first drawer electrode 111 is in contact with the second electrode 51 of the first cartridge 20A, the third electrode 52 of the first cartridge 20A is in contact with the second electrode 51 of the second cartridge 20B, the third electrode 52 of the second cartridge 20B is in contact with the second electrode 51 of the third cartridge 20C, the third electrode 52 of the third cartridge 20C is in contact with the second electrode 51 of the fourth cartridge 20D, and the third electrode 52 of the fourth cartridge 20D is in contact with the second drawer electrode 112.

The image forming apparatus 1 is configured to determine whether all of the cartridges 20 are attached to the drawer 10 on the basis of whether current flows through the circuit including the first drawer electrode 111, the cartridge electrodes 50 of the four cartridges 20, and the second drawer electrode 112. Specifically, when current flows through the circuit, the image forming apparatus 1 determines that all of the cartridges 20 are attached to the drawer 10. On the other hand, when no current flows through the circuit, the image forming apparatus 1 determines that not all of the cartridges 20 are attached to the drawer 10.

The first side cover 33 of each of the four cartridges 20 includes a protruding portion 332. The third drawer wall 103 of the drawer 10 includes four recesses 120. The protruding portion 332 of each of the cartridges 20 protrudes in the third direction. The protruding portion 332 is positioned at the other end portion of the first side cover 33 in the first direction. The recesses 120 are openings that are open to the one side in the third direction. The recesses 120 are arranged corresponding to the four cartridges 20 (the first through fourth cartridges 20A through 20D). The protruding portion 332 of the cartridge 20 is received in the corresponding recess 120 of the drawer 10 in a state where the cartridge 20 is attached to the drawer 10.

As illustrated in FIG. 9, the drawer frame 100 further includes a fourth drawer wall 104, a fifth drawer wall 105 as an example of the “drawer wall”, and four beams 106. The drawer 10 further includes pressing projections 130 and four cartridge guides 140.

The fourth drawer wall 104 is positioned at the other end portion of the drawer frame 100 in the second direction and at the other end portion of the drawer frame 100 in the third direction. The fourth drawer wall 104 extends in the first direction. The fourth drawer wall 104 connects the other end portion of the first drawer wall 101 in the second direction and the other end portion of the second drawer wall 102 in the second direction to each other. The third drawer wall 103 and the fourth drawer wall 104 oppose each other in the second direction.

The fifth drawer wall 105 is positioned at the one end portion of the drawer frame 100 in the second direction. The fifth drawer wall 105 extends in the first direction. The fifth drawer wall 105 connects the one end portion of the first drawer wall 101 in the second direction and the one end portion of the second drawer wall 102 in the second direction to each other. The fifth drawer wall 105 opposes, in the second direction, the one end portion in the second direction of the cartridge frame 30 of each of the cartridges 20 in a state where the cartridge 20 is attached to the drawer 10.

The beams 106 extend in the second direction. The beams 106 connect the third drawer wall 103 and the fourth drawer wall 104 to each other. The four beams 106 are arranged to be spaced apart from each other in the first direction.

The pressing projections 130 are in contact with the main housing 2 in a state where the drawer 10 is in the first position in which the drawer 10 is accommodated in the main housing 2, thereby urging the drawer 10 toward the one end portion of the main housing 2 in the second direction. The pressing projections 130 are positioned at the other end portion of the drawer frame 100 in the second direction. The pressing projections 130 are positioned at the other end portion of the drawer frame 100 in the first direction. Specifically, the pressing projections 130 are disposed to protrude in the second direction from the other end portion of the second drawer wall 102 in the second direction. The pressing projections 130 include a first pressing projection 131 and a second pressing projection 132. The first pressing projection 131 and the second pressing projection 132 are arranged in the third direction.

Each of the cartridge guides 140 is configured to guide the attachment and the detachment of the corresponding cartridge 20 to and from the drawer 10. The cartridge guide 140 is configured to cause the cartridge 20 to move in a direction away from one end portion of the drawer 10 in the second direction during attachment of the cartridge 20 to the drawer 10. The cartridge guide 140 is also configured to cause the cartridge 20 to move in the direction away from the one end portion of the drawer 10 in the second direction during detachment of the cartridge 20 from the drawer 10. The cartridge guides 140 are disposed in one-to-one correspondence with the four cartridges 20.

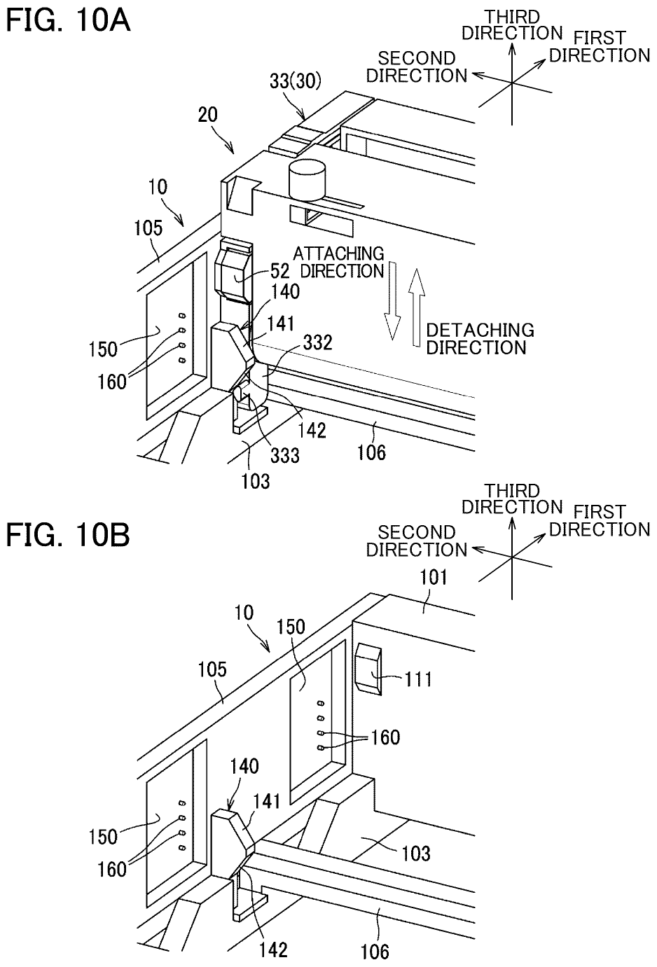

As illustrated in FIGS. 10A and 10B, each of the cartridge guides 140 has a first guide inclined surface 141, and a second guide inclined surface 142. The first guide inclined surface 141 is an example of the “guide inclined surface”. The second guide inclined surface 142 is also an example of the “guide inclined surface”.

The first guide inclined surface 141 is configured to guide the corresponding cartridge 20 during the attachment of the cartridge 20 to the drawer 10. The first guide inclined surface 141 is inclined so as to be farther from the one end portion of the main housing 2 in the second direction as the first guide inclined surface 141 extends in a direction from one end portion of the drawer 10 in the third direction toward the other end portion of the drawer 10 in the third direction. In other words, the first guide inclined surface 141 is inclined so as to be farther from the one end portion of the drawer 10 in the second direction as the first guide inclined surface 141 extends from the upstream side toward the downstream side in an attaching direction in which the cartridge 20 is attached to the drawer 10. The cartridge 20 is configured to be attached to the drawer 10 in the direction from the one end portion of the drawer 10 in the third direction toward the other end portion of the drawer 10 in the third direction.

The second guide inclined surface 142 is configured to guide the corresponding cartridge 20 during the detachment of the cartridge 20 from the drawer 10. The second guide inclined surface 142 is inclined so as to be farther from the one end portion of the drawer 10 in the second direction as the second guide inclined surface 142 extends in a direction from the other end portion of the drawer 10 in the third direction toward the one end portion of the drawer 10 in the third direction. In other words, the second guide inclined surface 142 is inclined so as to be farther from the one end portion of the drawer 10 in the second direction as the second guide inclined surface 142 extends from the upstream side toward the downstream side in a detaching direction in which the cartridge 20 is detached from the drawer 10. The cartridge 20 is configured to be detached from the drawer 10 in the direction from the other end portion of the drawer 10 in the third direction toward the one end portion of the drawer 10 in the third direction.

The cartridge frame 30 of each of the cartridges 20 includes a protrusion 333. The protrusion 333 protrudes from the other end portion of the protruding portion 332 of the first side cover 33 in the first direction toward the other side in the first direction. The protrusion 333 is configured to be guided by the corresponding cartridge guide 140 when the cartridge 20 is attached to and detached from the drawer 10. Specifically, during the attachment of the cartridge 20 to the drawer 10, the protrusion 333 contacts the first guide inclined surface 141 of the corresponding cartridge guide 140 and is guided by the first guide inclined surface 141. Also, during the detachment of the cartridge 20 from the drawer 10, the protrusion 333 contacts the second guide inclined surface 142 of the corresponding cartridge guide 140 and is guided by the second guide inclined surface 142.

In a state where the cartridge 20 is attached to the drawer 10, the protrusion 333 overlaps the third electrode 52 in position in the first direction and also overlaps the third electrode 52 in position in the second direction. In other words, in a state where the cartridge 20 is attached to the drawer 10, the protrusion 333 is disposed at a position overlapping the third electrode 52 when viewed in the third direction. In a state where the cartridge 20 is attached to the drawer 10, the protrusion 333 is positioned on the other side of the third electrode 52 in the third direction.

Also, in a state where the cartridge 20 is attached to the drawer 10, the cartridge guide 140 overlaps the third electrode 52 in position in the first direction and also overlaps the third electrode 52 in position in the second direction. In other words, in a state where the cartridge 20 is attached to the drawer 10, the cartridge guide 140 is disposed at a position overlapping the third electrode 52 when viewed in the third direction. In a state where the cartridge 20 is attached to the drawer 10, the cartridge guide 140 is positioned on the other side of the third electrode 52 in the third direction.

The fifth drawer wall 105 includes four recesses 150. Each of the recesses 150 is a recessed portion that is recessed toward one end portion of the fifth drawer wall 105 in the second direction from the other end portion of the fifth drawer wall 105 in the second direction. The recesses 150 are disposed in one-to-one correspondence with the four cartridges 20. In a state where the cartridge 20 is attached to the drawer 10, the recess 150 opposes one end portion of the corresponding cartridge 20 in the second direction.

The drawer 10 further includes relay electrodes 160 as an example of the “drawer electrode”. The relay electrodes 160 are electrodes configured to be electrically connected to the memory electrodes 71 of the corresponding cartridge 20. Specifically, the relay electrodes 160 are disposed corresponding to the first memory electrode 711, the second memory electrode 712, the third memory electrode 713, and the fourth memory electrode 714. The four relay electrodes 160 are arranged in the third direction. The four relay electrodes 160 are positioned in each of the recesses 150 of the fifth drawer wall 105. The relay electrodes 160 protrude in the second direction from the bottom surface of each of the recesses 150 (i.e., the surface of the recess 150 that faces in the second direction).

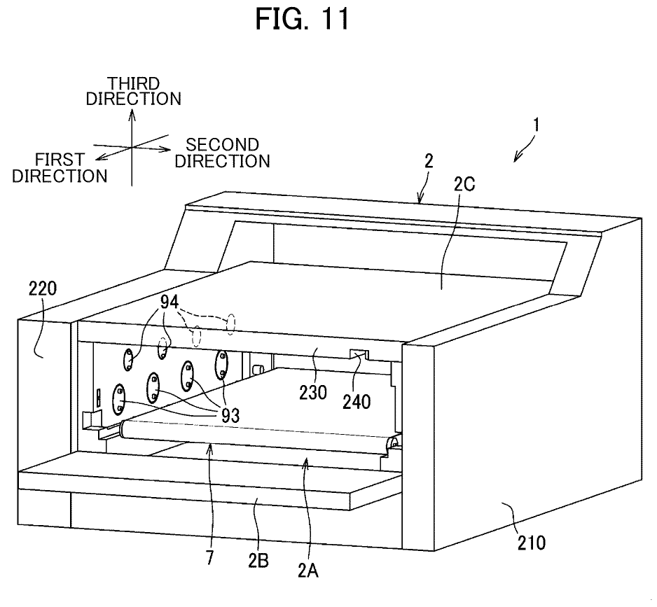

As illustrated in FIG. 11, the main housing 2 further includes a first main wall 210, a second main wall 220, and a third main wall 230. The first main wall 210 constitutes the one end portion of the main housing 2 in the second direction. The second main wall 220 constitutes the other end portion of the main housing 2 in the second direction. The first main wall 210 and the second main wall 220 oppose each other in the second direction.

The third main wall 230 constitutes one end portion of the main housing 2 in the third direction. The third main wall 230 connects one end portion of the first main wall 210 in the third direction and one end portion of the second main wall 220 in the third direction to each other.

The image forming apparatus 1 further includes four drum joints 93 and four developing joints 94. Each of the drum joints 93 is a member configured to transmit a drive force to the photosensitive drum 21 of the corresponding cartridge 20. Each of the developing joints 94 is a member configured to transmit a drive force to the developing roller 23 of the corresponding cartridge 20. The drum joints 93 and the developing joints 94 are positioned at the other end portion of the main housing 2 in the second direction. The drum joints 93 and the developing joints 94 are movable in the second direction relative to the second main wall 220.

The movement of the cover 2B from the open position to the closed position causes the drum joints 93 and the developing joints 94 to be moved in a direction toward the one end portion of the main housing 2 in the second direction from the other end portion of the main housing 2 in the second direction. The drum joints 93 are movable toward the one end portion of the main housing 2 in the second direction from the other end portion of the main housing 2 in the second direction to be coupled to the drum couplings 91 of the corresponding cartridges 20. The developing joints 94 are movable toward the one end portion of the main housing 2 in the second direction from the other end portion of the main housing 2 in the second direction to be coupled to the developing couplings 92 of the corresponding cartridges 20.

The movement of the cover 2B from the closed position to the open position causes the drum joints 93 and the developing joints 94 to be moved in a direction from the one end portion of the main housing 2 in the second direction toward the other end portion of the main housing 2 in the second direction. The drum joints 93 are disconnected from the drum couplings 91 of the corresponding cartridges 20 from the state in which the drum joints 93 are coupled to the drum couplings 91 by moving from the one end portion of the main housing 2 in the second direction toward the other end portion of the main housing 2 in the second direction. Similarly, the developing joints 94 are disconnected from the developing couplings 92 of the corresponding cartridges 20 from the state in which the developing joints 94 are coupled to the developing couplings 92 by moving from the one end portion of the main housing 2 in the second direction toward the other end portion of the main housing 2 in the second direction.

The main housing 2 further includes a guide groove 240. The guide groove 240 is a groove configured to guide the bosses 60 of the cartridges 20 (see FIG. 2B) when the drawer 10 to which the cartridges 20 are attached is moved toward the first position from the second position.

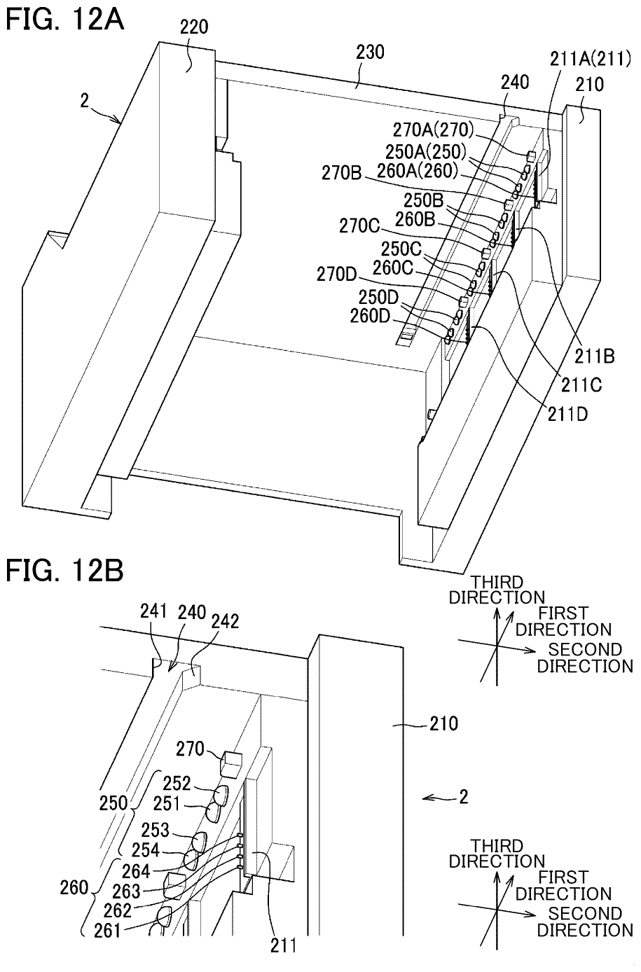

As illustrated in FIG. 12A, the guide groove 240 is positioned at one end portion of the third main wall 230 in the second direction. The guide groove 240 has a recessed shape to be recessed toward one end portion of the third main wall 230 in the third direction from the other end portion of the third main wall 230 in the third direction. The guide groove 240 extends in the first direction.

As illustrated in FIG. 12B, the guide groove 240 has an opening portion 241, and a first inclined surface 242. The opening portion 241 is an opening portion configured to receive the bosses 60 into the guide groove 240. The opening portion 241 is positioned at one end portion of the guide groove 240 in the first direction. The first inclined surface 242 is an example of the “inclined surface of the guide groove”.

The first inclined surface 242 defines one end portion of the opening portion 241 in the second direction. The first inclined surface 242 is inclined so that the width of the guide groove 240 in the second direction increases as the first inclined surface 242 extends toward the one end portion in the first direction from the other end portion in the first direction. In other words, the first inclined surface 242 is inclined so as to be farther from the one end portion of the main housing 2 in the second direction as the first inclined surface 242 extends toward the other end in the first direction from the one end in the first direction. Further in other words, the first inclined surface 242 is inclined so that the width of the opening portion 241 in the second direction increases as the first inclined surface 242 extends toward the one end portion of the guide groove 240 in the first direction.

The drawer 10 is configured to be mounted in the main housing 2 along the guide groove 240 from the one end portion of the main housing 2 in the first direction toward the other end portion of the main housing 2 in the first direction. The drawer 10 is also configured to be drawn out of the main housing 2 along the guide groove 240 from the other end portion of the main housing 2 in the first direction toward the one end portion of the main housing 2 in the first direction.

As illustrated in FIGS. 12A and 12B, the image forming apparatus 1 further includes first main-body electrodes 250, and second main-body electrodes 260. The first main-body electrodes 250 and the second main-body electrodes 260 are positioned at the one end portion of the main housing 2 in the second direction. Specifically, the first main-body electrodes 250 and the second main-body electrodes 260 are disposed on the first main wall 210. The first main-body electrodes 250 are each an example of the “main-body electrode”.

The first main-body electrodes 250 are configured to contact the first electrodes 40 of the corresponding cartridge 20. Each of the first main-body electrodes 250 includes a main-body drum electrode 251, a main-body charging electrode 252, a main-body developing electrode 253, and a main-body supply electrode 254. The main-body charging electrode 252, the main-body drum electrode 251, the main-body developing electrode 253, and the main-body supply electrode 254 are arranged in the first direction. The main-body drum electrode 251 is connected to ground. The main-body drum electrode 251 is configured to contact the drum electrode 41 of the corresponding cartridge 20.

The main-body charging electrode 252 is an electrode for applying voltage to the charging roller 22. The main-body charging electrode 252 is configured to contact the charging electrode 42 of the corresponding cartridge 20. The main-body developing electrode 253 is an electrode for applying voltage to the developing roller 23. The main-body developing electrode 253 is configured to contact the developing electrode 43 of the corresponding cartridge 20. The main-body supply electrode 254 is an electrode for applying voltage to the supply roller 24. The main-body supply electrode 254 is configured to contact the supply electrode 44 of the corresponding cartridge 20.

The first main-body electrodes 250 include first main-body electrodes 250A configured to contact the first electrodes 40 of the first cartridge 20A, first main-body electrodes 250B configured to contact the first electrodes 40 of the second cartridge 20B, first main-body electrodes 250C configured to contact the first electrodes 40 of the third cartridge 20C, and first main-body electrodes 250D configured to contact the first electrodes 40 of the fourth cartridge 20D. Each of the first main-body electrodes 250A through 250D includes the main-body drum electrode 251, the main-body charging electrode 252, the main-body developing electrode 253, and the main-body supply electrode 254.

The second main-body electrodes 260 are electrodes configured to be electrically connected to the memory electrodes 71 of the corresponding cartridges 20 via the relay electrodes 160 of the drawer 10. Each of the second main-body electrodes 260 includes four electrodes 261 through 264 arranged in the third direction. Each of the electrodes 261 through 264 protrudes from the first main wall 210 toward the other side in the second direction.

The electrode 261 is configured to be electrically connected to the first memory electrode 711 via the relay electrode 160. The electrode 262 is configured to be electrically connected to the second memory electrode 712 via the relay electrode 160. The electrode 263 is configured to be electrically connected to the third memory electrode 713 via the relay electrode 160. The electrode 264 is configured to be electrically connected to the fourth memory electrode 714 via the relay electrode 160.

The second main-body electrodes 260 include second main-body electrodes 260A configured to be electrically connected to the memory electrodes 71 of the first cartridge 20A, second main-body electrodes 260B configured to be electrically connected to the memory electrodes 71 of the second cartridge 20B, second main-body electrodes 260C configured to be electrically connected to the memory electrodes 71 of the third cartridge 20C, and second main-body electrodes 260D configured to be electrically connected to the memory electrodes 71 of the fourth cartridge 20D. Each of the second main-body electrodes 260A through 260D includes the electrodes 261 through 264.

The first main wall 210 includes four protective walls 211. The protective walls 211 protrude in the second direction. The protective walls 211 extend in the third direction. The protective walls 211 include a first protective wall 211A, a second protective wall 211B, a third protective wall 211C, and a fourth protective wall 211D. The first protective wall 211A, the second protective wall 211B, the third protective wall 211C, and the fourth protective wall 211D are arranged in the first direction.

The first protective wall 211A is positioned on the one side of the second main-body electrodes 260A in the first direction. The second protective wall 211B is positioned on the one side of the second main-body electrodes 260B in the first direction. The second protective wall 211B is positioned between the second main-body electrodes 260A and the second main-body electrodes 260B. The third protective wall 211C is positioned on the one side of the second main-body electrodes 260C in the first direction. The third protective wall 211C is positioned between the second main-body electrodes 260B and the second main-body electrodes 260C.

The fourth protective wall 211D is positioned on the one side of the second main-body electrodes 260D in the first direction. The fourth protective wall 211D is positioned between the second main-body electrodes 260C and the second main-body electrodes 260D. The protective walls 211 protrude further toward the other side in the second direction than the second main-body electrodes 260 do.

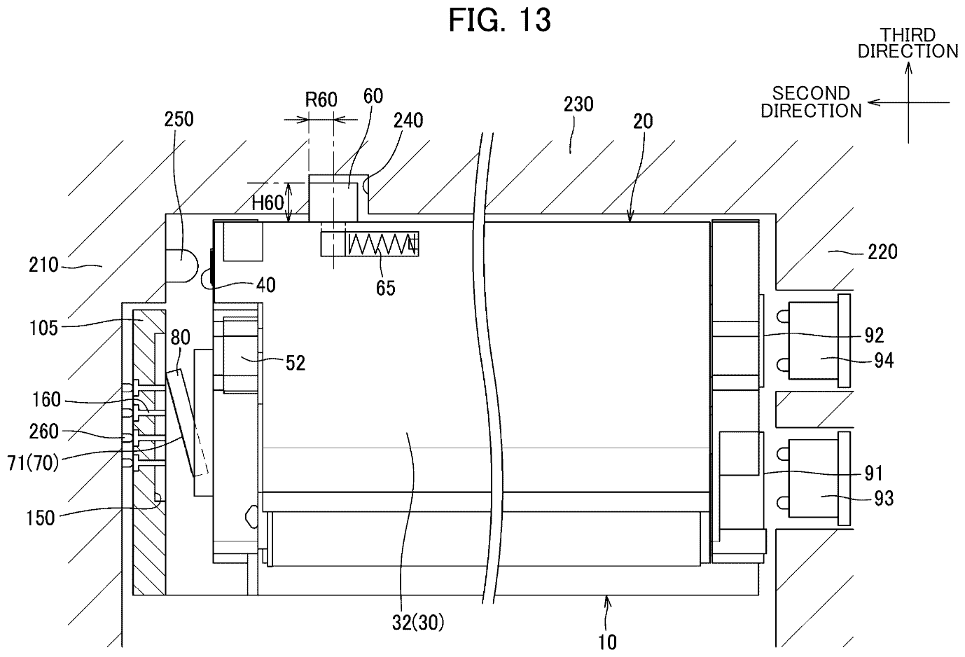

As illustrated in FIG. 13, the boss 60 of each of the cartridges 20 is configured to be guided by the guide groove 240 of the main housing 2 when the drawer 10 to which the cartridge 20 is attached is moved toward the first position from the second position. The boss 60 is movable in the second direction relative to the cartridge frame 30.

Specifically, the boss 60 is positioned at the one end portion of the developing frame 32 in the third direction, and is movable in the second direction relative to the developing frame 32. The boss 60 is supported by the developing frame 32 so as to be linearly movable in the second direction.

Each of the cartridges 20 also includes a resilient member 65. The resilient member 65 urges the boss 60 toward the one side in the second direction. In other words, the resilient member 65 urges the boss 60 in a direction toward the first electrodes 40 in the second direction. For example, the resilient member 65 is a compression coil spring. The boss 60 is movable toward the other side in the second direction against the urging force of the resilient member 65. In other words, the boss 60 is movable in a direction away from the first electrodes 40 in the second direction against the urging force of the resilient member 65.

The urging force of the resilient member 65 is greater than the frictional force generated between the cartridge 20 and the drawer 10 when the cartridge 20 is moved in the second direction relative to the drawer 10. Therefore, the cartridge frame 30 is moved toward the other side in the second direction due to the urging force of the resilient member 65 while the boss 60 is restricted from moving significantly in the second direction within the guide groove 240.

A protruding amount H60 by which the boss 60 protrudes in the third direction is greater than a radius R60 of the boss 60, which has a cylindrical shape. In a state where the drawer 10 is in the first position, the first main wall 210 of the main housing 2 opposes the one end portion of the drawer 10 in the second direction, and the second main wall 220 opposes the other end portion of the drawer 10 in the second direction. In a state where the drawer 10 is in the first position, the first main wall 210 of the main housing 2 opposes the one end portion of the drawer frame 100 in the second direction, and the second main wall 220 opposes the other end portion of the drawer frame 100 in the second direction.

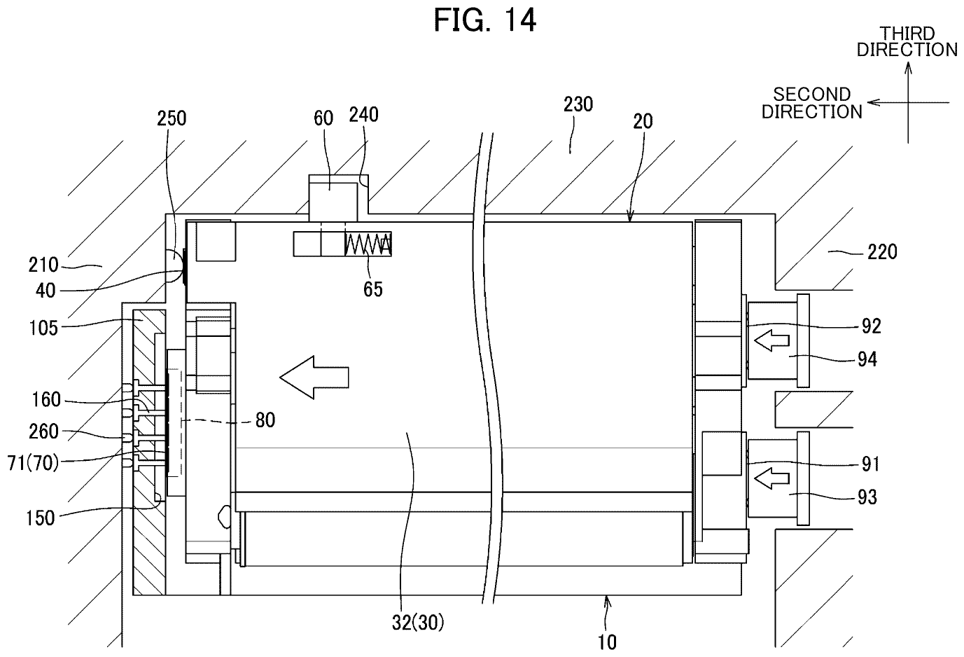

As illustrated in FIG. 14, in a state where the drawer 10 to which the cartridge 20 is attached is in the first position, the drum joint 93 connected to the drum coupling 91 and the developing joint 94 connected to the developing coupling 92 press and move the cartridge 20 in a direction toward the one end portion of the main housing 2 in the second direction from the other end portion of the main housing 2 in the second direction. Specifically, in a state where the drawer 10 to which the cartridge 20 is attached is in the first position, the cartridge 20 is moved in a direction toward the fifth drawer wall 105 and the first main wall 210 in the second direction by being pressed toward the one side in the second direction by the corresponding drum joint 93 and developing joint 94.

As a result, the first electrodes 40 are brought into contact with the corresponding first main-body electrodes 250, and the memory electrodes 71 are brought into contact with the corresponding relay electrodes 160, thereby establishing electrical connection with the corresponding second main-body electrodes 260 via the relay electrodes 160.

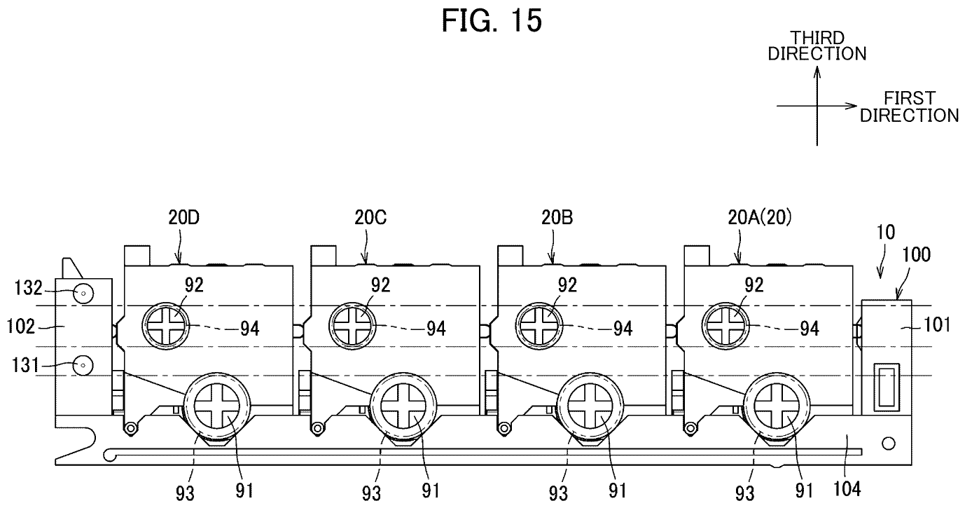

As illustrated in FIG. 15, the first pressing projection 131 is positioned between the drum joints 93 and the developing joints 94 in the third direction. The second pressing projection 132 is positioned closer in the third direction to one end portion of the drawer frame 100 in the third direction than the drum joints 93 and the developing joints 94 are to the one end portion of the drawer frame 100 in the third direction.

In other words, the first pressing projection 131 is positioned further toward the one side in the third direction than the drum joints 93. The developing joints 94 are positioned further toward the one side in the third direction than the first pressing projection 131. The second pressing projection 132 is positioned further toward the one side in the third direction than the developing joints 94.

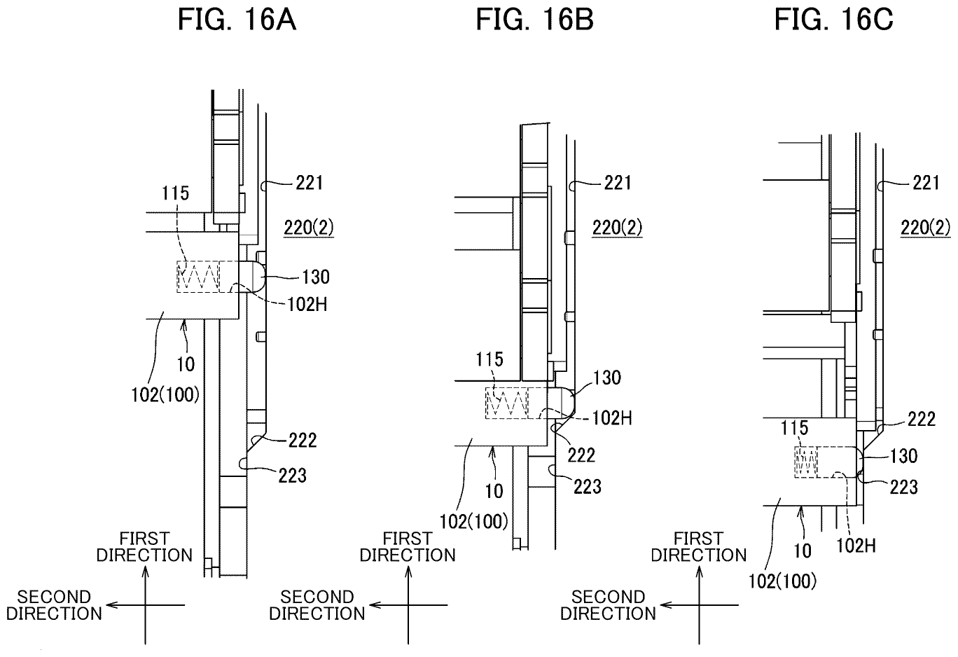

As illustrated in FIG. 16A, the pressing projections 130 are movable in the second direction relative to the drawer frame 100. Specifically, the pressing projections 130 are respectively fitted in holes 102H formed in the second drawer wall 102 so as to be movable in the second direction. A resilient member 115 is disposed between each pressing projection 130 and the bottom of the corresponding hole 102H. For example, the resilient member 115 is a compression coil spring. Each of the pressing projections 130 is movable elastically in the second direction due to the presence of the resilient member 115 between the pressing projection 130 and the bottom of the corresponding hole 102H.

The second main wall 220 of the main housing 2 has a first main surface 221, a second main surface 222, and a third main surface 223. The pressing projections 130 are configured to contact the first main surface 221, the second main surface 222, and the third main surface 223. The first main surface 221 and the third main surface 223 are surfaces orthogonal to the second direction. The first main surface 221 and the third main surface 223 extend at least in the first direction. The third main surface 223 is positioned further toward the one side in the second direction than the first main surface 221.

The second main surface 222 is a surface that connects the first main surface 221 and the third main surface 223 to each other. The second main surface 222 is inclined relative to the first direction. Specifically, the second main surface 222 is inclined so as to approach the one end portion of the main housing 2 in the second direction as the second main surface 222 extends from one end in the first direction toward the other end in the first direction.

As illustrated in FIGS. 16A and 16B, during the movement of the drawer 10 from the second position to the first position, the pressing projections 130 first contact the first main surface 221 of the second main wall 220, and subsequently contact the second main surface 222. As the drawer 10 is further moved toward the first position from the state in which the pressing projections 130 are in contact with the second main surface 222, the pressing projections 130 are moved toward the one side in the second direction while elastically deforming the resilient members 115.

As illustrated in FIG. 16C, the pressing projections 130 contact the third main surface 223 of the second main wall 220 in a state where the drawer 10 is in the first position, thereby urging the drawer 10 toward the one end portion of the main housing 2 in the second direction due to the restoring force of the resilient members 115. This operation stabilizes the electrical contact between the relay electrodes 160 (see FIG. 14) and the second main-body electrodes 260, for example.

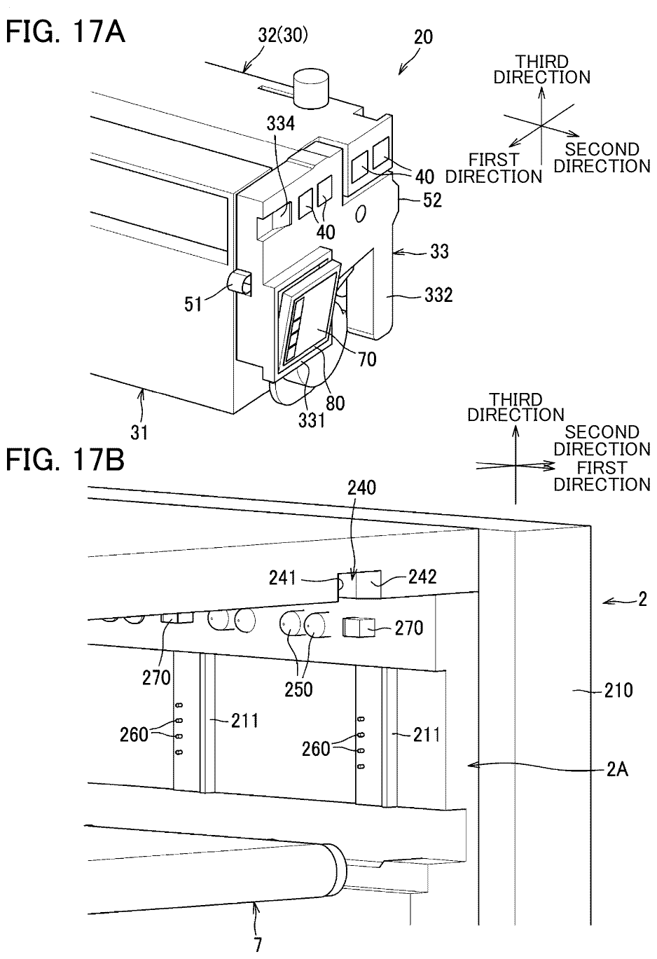

As illustrated in FIGS. 17A and 17B, the first side cover 33 of each of the cartridges 20 has an inclined surface 334. The main housing 2 includes projections 270 that the inclined surfaces 334 of the corresponding cartridges 20 are configured to contact.

The inclined surface 334 is positioned at the one end portion of the first side cover 33 in the first direction and at one end portion of the first side cover 33 in the second direction. The inclined surface 334 is positioned closer to the one end portion of the first side cover 33 in the first direction than the first electrodes 40 are to the one end portion of the first side cover 33 in the first direction. In a state where the cartridge 20 is attached to the drawer 10, the inclined surface 334 is inclined so as to be farther from the one end portion of the drawer 10 in the second direction as the inclined surface 334 extends toward one end in the first direction from the other end in the first direction. In other words, in a state where the cartridge 20 is attached to the drawer 10, the inclined surface 334 is inclined so as to be farther from the one end portion of the drawer 10 in the second direction as the inclined surface 334 extends toward the one end portion of the drawer 10 in the first direction. The inclined surface 334 is configured to contact the corresponding projection 270 of the main housing 2 when the drawer 10 to which the cartridge 20 is attached is moved from the first position to the second position.

The projections 270 protrude from the first main wall 210 toward the other side in the second direction. As illustrated in FIG. 12A, the projections 270 include a first projection 270A, a second projection 270B, a third projection 270C, and a fourth projection 270D. The first projection 270A, the second projection 270B, the third projection 270C, and the fourth projection 270D are arranged in the first direction.

The first projection 270A is positioned on the one side of the first main-body electrodes 250A in the first direction. The second projection 270B is positioned on the one side of the first main-body electrodes 250B in the first direction. The second projection 270B is positioned between the first main-body electrodes 250A and the first main-body electrodes 250B. The third projection 270C is positioned on the one side of the first main-body electrodes 250C in the first direction. The third projection 270C is positioned between the first main-body electrodes 250B and the first main-body electrodes 250C.

The fourth projection 270D is positioned on the one side of the first main-body electrodes 250D in the first direction. The fourth projection 270D is positioned between the first main-body electrodes 250C and the first main-body electrodes 250D. The projections 270 protrude further toward the other side in the second direction than the first main-body electrodes 250 do.

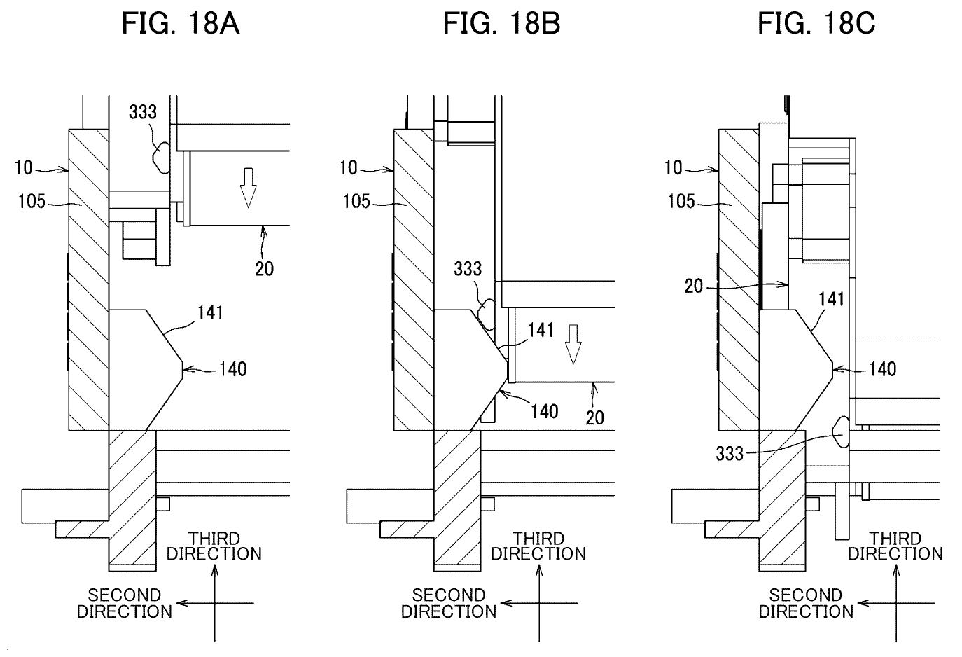

Next, the operation of attaching and detaching the cartridge 20 to and from the main housing 2 will be described. As illustrated in FIG. 18A, when attaching the cartridge 20 from the one side in the third direction toward the other side in the third direction to the drawer 10 which is in the second position, the protrusion 333 of the cartridge 20 may contact the first guide inclined surface 141 of the corresponding cartridge guide 140, as illustrated in FIG. 18B, depending on the position of the cartridge 20 in the second direction.

As the cartridge 20 is further moved toward the other side in the third direction from the state in which the protrusion 333 is in contact with the first guide inclined surface 141, the protrusion 333 is moved along the first guide inclined surface 141 from the one side in the third direction toward the other side in the third direction while moving away from the one end portion of the drawer 10 in the second direction. Consequently, the cartridge 20 is moved from the one side in the third direction toward the other side in the third direction while moving toward the other side in the second direction, i.e., moving away from the fifth drawer wall 105 of the drawer 10.

As illustrated in FIG. 18C, the attachment of the cartridge 20 to the drawer 10 is completed. In a state where the cartridge 20 is attached to the drawer 10 and the drawer 10 is in the second position, the cartridge 20 is still movable in the second direction relative to the drawer 10.

Then, the drawer 10 to which the cartridge 20 is attached is moved from the second position illustrated in FIG. 2B to the first position illustrated in FIG. 2A. At this time, the boss 60 of the cartridge 20 is inserted into the guide groove 240 of the main housing 2.

When the boss 60 is inserted into the guide groove 240, the boss 60 may contact the first inclined surface 242 of the opening portion 241 illustrated in FIGS. 12A and 12B depending on the position of the cartridge 20 in the second direction. As the drawer 10 is further moved toward the first position from the state in which the boss 60 is in contact with the first inclined surface 242, the boss 60 is guided along the first inclined surface 242 in a direction away from the one end portion of the main housing 2 in the second direction, whereby the cartridge 20 is guided in the direction away from the one end portion of the main housing 2 in the second direction, as illustrated in FIG. 13.

When the drawer 10 is moved to the first position and the cover 2B is moved to the closed position, the drum joint 93 is connected to the drum coupling 91, and the developing joint 94 is connected to the developing coupling 92, as illustrated in FIG. 14. The cartridge 20 is then moved in a direction toward the fifth drawer wall 105 in the second direction due to the pressure applied by the drum coupling 91 and the developing coupling 92.

This movement of the cartridge 20 causes the first electrodes 40 to contact the first main-body electrodes 250. Further, the memory holder 80 and the cartridge memory 70 are pivotally moved toward the other side in the second direction against the urging force of the resilient member 85 (see FIGS. 6A and 6B), thereby causing the memory electrodes 71 to contact the relay electrodes 160. As a result, the memory electrodes 71 are electrically connected to the second main-body electrodes 260 via the relay electrodes 160.

When detaching the cartridge 20 from the main housing 2, the cover 2B is first moved to the open position. The movement of the cover 2B toward the open position causes the drum joint 93 to separate from the drum coupling 91 and the developing joint 94 to separate from the developing coupling 92, as illustrated in FIG. 13, whereby the cartridge frame 30 of the cartridge 20 is moved in a direction away from the fifth drawer wall 105 in the second direction due to the urging force of the resilient member 65.

As a result, the first electrodes 40 separate from the first main-body electrodes 250, and the memory electrodes 71 separate from the relay electrodes 160. At this time, the memory holder 80 and the cartridge memory 70 are pivotally moved toward the one side in the second direction due to the urging force of the resilient member 85 (see FIGS. 6A and 6B).

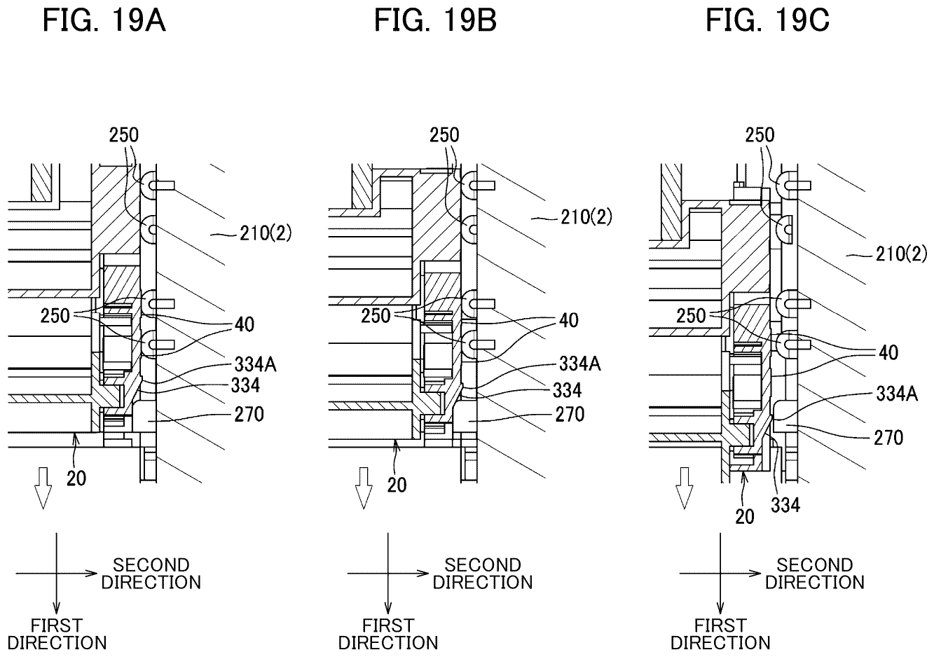

Next, the drawer 10 is moved from the first position toward the second position. In a case where the cartridge 20 is not sufficiently moved toward the other side in the second direction as illustrated in FIG. 19A, the inclined surface 334 of the cartridge 20 contacts the corresponding projection 270 of the main housing 2, as illustrated in FIG. 19B. As the drawer 10 is further moved toward the second position from the state in which the inclined surface 334 is in contact with the projection 270, the cartridge 20 is moved toward the other side in the second direction due to the contact between the inclined surface 334 and the projection 270, as illustrated in FIG. 19C.

Note that, in the second direction, an other end portion 334A of the inclined surface 334 in the first direction is positioned further toward the one side in the second direction than the one end faces of the first electrodes 40 in the second direction. As a result, in the state illustrated in FIG. 19C, the projection 270 is positioned further toward the one side in the second direction than the one end faces of the first electrodes 40 in the second direction. This positional relationship inhibits contact between the projection 270 and the first electrodes 40 during the movement of the drawer 10 from the first position to the second position.

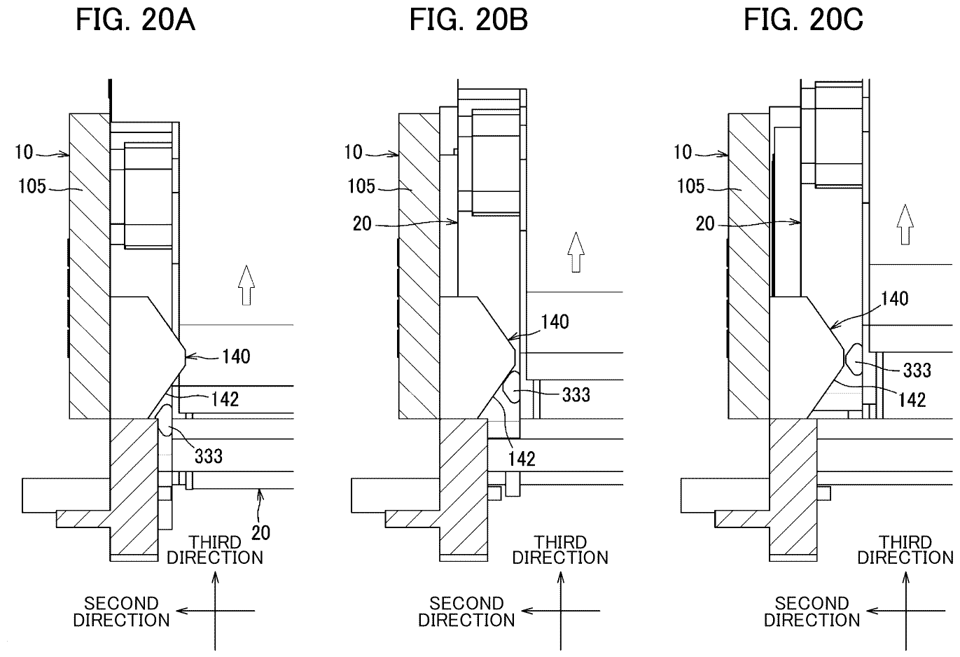

After the drawer 10 reaches the second position, the cartridge 20 is detached from the drawer 10 as illustrated in FIG. 20A. As the cartridge 20 is detached from the other side in the third direction toward the one side in the third direction relative to the drawer 10, the protrusion 333 may contact the second guide inclined surface 142 of the cartridge guide 140 depending on the position of the cartridge 20 in the second direction.

As the cartridge 20 is further moved toward the one side in the third direction from the state in which the protrusion 333 is in contact with the second guide inclined surface 142, the protrusion 333 is moved along the second guide inclined surface 142 from the other side in the third direction toward the one side in the third direction while moving away from the one end portion of the drawer 10 in the second direction, as illustrated in FIGS. 20B and 20C. Consequently, the cartridge 20 is moved from the other side in the third direction toward the one side in the third direction while moving toward the other side in the second direction, i.e., away from the fifth drawer wall 105 in the second direction. Thereafter, the detachment of the cartridge 20 from the drawer 10 is completed.

Next, the advantages of the above embodiment will be described. Since each of the cartridges 20 includes the boss 60 configured to be guided by the main housing 2, the cartridge 20 can be restricted from moving significantly in the second direction when the drawer 10 is moved toward the first position from the second position. Specifically, since each of the cartridge 20 includes the boss 60 and the main housing 2 includes the guide groove 240 configured to guide the boss 60, the significant movement of the cartridge 20 in the second direction can be inhibited during the movement of the drawer 10 from the second position to the first position. This operation restricts the first electrodes 40, which are the electrodes of the cartridge 20, from contacting the main housing 2.

The urging force of the resilient member 65 is greater than the frictional force generated between the cartridge 20 and the drawer 10 when the cartridge 20 is moved in the second direction. This configuration enables the cartridge 20 to be moved in a direction in which the first electrodes 40 are away from the main housing 2 in the second direction (specifically, away from the second main-body electrodes 260 of the main housing 2 in the second direction) when the drawer 10 is moved toward the first position from the second position.

Since the second electrode 51 and the third electrode 52 are electrically connected to each other, an electrical connection can be established from either one end portion of the cartridge 20 in the first direction or the other end portion of the cartridge 20 in the first direction, or from both. Also, the cartridges 20 which are arranged in the first direction can be electrically connected to one another.

The guide groove 240 has the first inclined surface 242 positioned on the one end portion of the opening portion 241 in the second direction. This configuration allows the cartridge 20 to be moved in the direction away from the one end portion of the main housing 2 in the second direction when the drawer 10 is moved from the second position to the first position.

The cartridge 20 is configured to be pressed by the corresponding drum joint 93 and developing joint 94 and moved in the second direction, thereby stabilizing the contact between the first electrodes 40 and the corresponding first main-body electrodes 250 when the first electrodes 40 contact the first main-body electrodes 250.

The cartridge 20 is configured to be pressed by the corresponding drum joint 93 and developing joint 94 and moved in the second direction, thereby stabilizing the contact between the memory electrodes 71 and the corresponding relay electrodes 160 when the memory electrodes 71 contact the relay electrodes 160.

Since the drawer 10 includes the cartridge guides 140, the contact of the side surface of each of the cartridges 20 with the drawer 10 can be restricted when the cartridge 20 is attached to the drawer 10. Specifically, the cartridge guide 140 inhibits the contact of the one side surface of the cartridge frame 30 in the second direction with the drawer 10 when the cartridge 20 is attached to the drawer 10.

Accordingly, the electrodes of the cartridge 20, such as the memory electrodes 71 of the cartridge memory 70, can also be restricted from contacting the drawer 10 when the cartridge 20 is attached to the drawer 10. In other words, the contact of the memory electrodes 71, which are positioned on the one end portion of the cartridge frame 30 in the second direction, with the drawer 10 can be restricted when the cartridge 20 is attached to the drawer 10.

Further, the mounting load of the cartridge 20 can be made smaller since the contact between the side surface of the cartridge frame 30 and the drawer 10 can be inhibited when the cartridge 20 is attached to the drawer 10.

The cartridge guide 140 for the first cartridge 20A causes the first cartridge 20 to be moved in the second direction during the attachment of the first cartridge 20A to the drawer 10. This configuration inhibits the second electrode 51 of the first cartridge 20A from contacting the first drawer electrode 111. Similarly, the cartridge guide 140 for the fourth cartridge 20D causes the fourth cartridge 20D to be moved in the second direction during the attachment of the fourth cartridge 20D to the drawer 10. This configuration inhibits the third electrode 52 of the fourth cartridge 20D from contacting the second drawer electrode 112. Accordingly, the mounting load of the cartridges 20 can further be reduced.

Each of the cartridge guides 140 includes the second guide inclined surface 142. The second guide inclined surface 142 can guide the corresponding cartridge 20 to be moved in the direction away from the one end portion of the drawer 10 in the second direction also when the cartridge 20 is detached from the drawer 10, thereby inhibiting the contact of the side surface of the cartridge 20 with the drawer 10 when the cartridge 20 is detached from the drawer 10. Specifically, the contact of the one side surface of the cartridge frame 30 in the second direction with the drawer 10 can be inhibited when the cartridge 20 is detached from the drawer 10.

In a state where the cartridge 20 is attached to the drawer 10, the cartridge guide 140 overlaps the third electrode 52 in position in the first direction and also overlaps the third electrode 52 in position in the second direction, thereby allowing the cartridge guide 140 to be compact. Accordingly, the enlargement of the drawer 10 can be restricted.

In a state where the cartridge 20 is attached to the drawer 10, the protrusion 333 overlaps the third electrode 52 in position in the first direction and also overlaps the third electrode 52 in position in the second direction. This configuration can reduce the size of the protrusion 333, which is configured to be guided by the cartridge guide 140. Accordingly, the enlargement of the cartridge 20 can be restricted.

Since the cartridge 20 includes the memory holder 80 that holds the cartridge memory 70, the cartridge memory 70 can be protected using the memory holder 80.

Since the drawer 10 includes the pressing projections 130, the drawer 10 can be guided to be moved toward the one end portion of the main housing 2 in the second direction in a state where the drawer 10 is in the first position. This configuration stabilizes the electrical contact between the relay electrodes 160 and the second main-body electrodes 260.

The first pressing projection 131 is positioned between the drum joints 93 and the developing joints 94 in the third direction, thereby inhibiting interference of the first pressing projection 131 with the drum joints 93 and the developing joints 94 during the movement of the drawer 10 between the first position and the second position.

Since the second pressing projection 132 is positioned closer in the third direction to the one end portion of the drawer frame 100 in the third direction than the drum joints 93 and the developing joints 94 are to the one end portion of the drawer frame 100 in the third direction, interference of the second pressing projection 132 with the drum joints 93 and the developing joints 94 can be avoided during the movement of the drawer 10 between the first position and the second position.

Since the cartridge memory 70 is movable in the second direction relative to the cartridge frame 30, a load to be imparted on the cartridge memory 70 can be reduced, whereby the cartridge memory 70 can be protected.

The cartridge 20 includes the resilient member 85 that urges the memory holder 80, thereby urging the memory electrodes 71 of the cartridge memory 70 against the relay electrodes 160, which are the electrodes of the drawer 10, using the urging force of the resilient member 85.

Since the color of the memory holder 80 corresponds to the color of the toner accommodated in the cartridge frame 30, the color of the toner accommodated in the cartridge frame 30 can be recognized based on the color of the memory holder 80.

Since the first side cover 33 has the inclined surface 334, the cartridge 20 can be guided to be moved in the direction away from the one end portion of the main housing 2 in the second direction when the drawer 10 is moved from the first position to the second position. This configuration inhibits the contact of the first electrodes 40 with the main housing 2.

The developing electrode 43 protrudes further in the second direction than the drum electrode 41 does. This configuration can reduce a protruding amount by which the electrode in the main housing 2 which is configured to be electrically connected to the developing electrode 43 protrudes in the second direction. Specifically, the above configuration can reduce a protruding amount by which the main-body developing electrode 253 protrudes in the second direction. The same is applied with respect to the main-body supply electrode 254.

The developing frame 32 is pivotally movable relative to the drum frame 31, and the length L43 of the developing electrode 43 in the first direction is greater than the length L41 of the drum electrode 41 in the first direction. This configuration ensures the contact between the developing electrode 43 and the electrode of the main housing 2 regardless of the pivotal movement of the developing frame 32. Specifically, the contact between the developing electrode 43 and the main-body developing electrode 253 can be maintained regardless of the pivotal movement of the developing frame 32. The same is applied with respect to the contact between the supply electrode 44 and the main-body supply electrode 254.

The main housing 2 includes the protective walls 211 that protrude further in the second direction than the second main-body electrodes 260 do. This configuration inhibits contact of the drawer 10 with the second main-body electrodes 260 when the drawer 10 is moved from the second position to the first position, thereby protecting the second main-body electrodes 260.

The projections 270 of the main housing 2 protrude further in the second direction than the first main-body electrodes 250 do. This configuration inhibits contact of the cartridges 20 with the first main-body electrodes 250 when the drawer 10 to which the cartridges 20 are attached is moved from the second position to the first position, thereby protecting the first main-body electrodes 250.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

The following description focuses on the points that are different from the above embodiment. Note that components having substantially the same structures as those in the above embodiment are designated with the same reference numerals as those in the above embodiment and the descriptions regarding these components will be omitted.

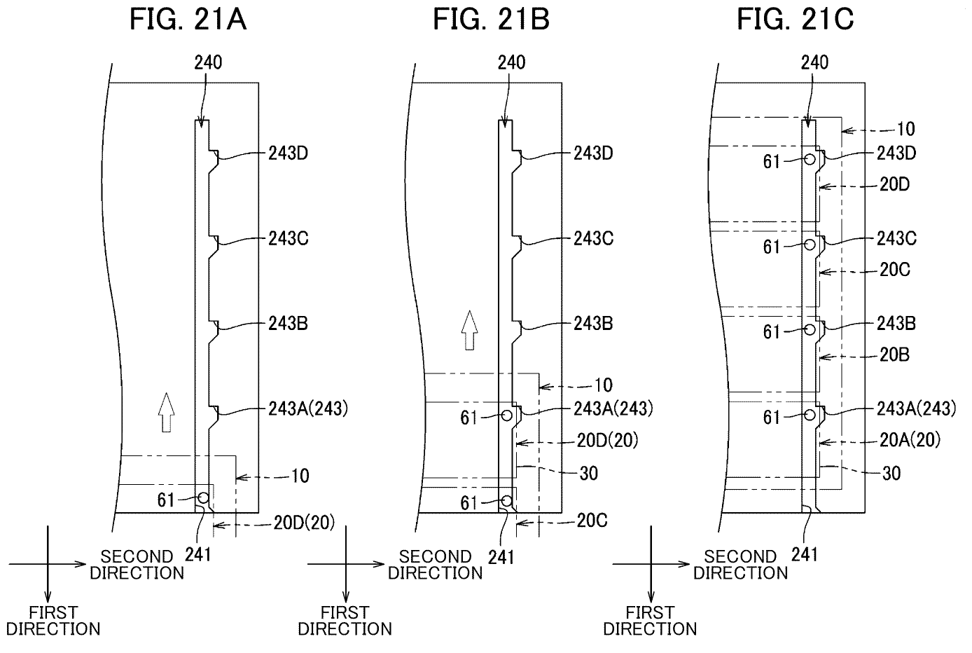

First, a first modification will be described. As illustrated in FIGS. 21A to 21C, each of the cartridges 20 (the first through fourth cartridges 20A through 20D) includes a boss 61 in place of the boss 60 in the above embodiment. The boss 61 protrudes in the third direction. The boss 61 is positioned at the one end portion of the cartridge frame 30 in the third direction. The boss 61 is positioned at the other end portion of the cartridge frame 30 in the first direction. The boss 61 is positioned at the one end portion of the cartridge frame 30 in the second direction. The boss 61 has a columnar shape.

The boss 61 does not move relative to the cartridge frame 30. Specifically, the boss 61 is fixed to the cartridge frame 30, or is integrally formed with the cartridge frame 30. As illustrated in FIGS. 21A and 21B, the boss 61 is configured to be guided by the guide groove 240 of the main housing 2 when the drawer 10 to which the cartridge 20 is attached is moved from the second position to the first position.

The guide groove 240 also includes four recesses 243. The recesses 243 are recessed toward the one end portion of the main housing 2 in the second direction. Each of the recesses 243 is configured to receive the boss 61 of the corresponding cartridge 20 in a state where the drawer 10 to which the cartridge 20 is attached is in the first position illustrated in FIG. 21C. Specifically, the recesses 243 include a first recess 243A, a second recess 243B, a third recess 243C, and a fourth recess 243D.

The first recess 243A is configured to receive the boss 61 of the first cartridge 20A. The second recess 243B is configured to receive the boss 61 of the second cartridge 20B. The third recess 243C is configured to receive the boss 61 of the third cartridge 20C. The fourth recess 243D is configured to receive the boss 61 of the fourth cartridge 20D. Each of the recesses 243 is at the same position in the first direction as the boss 61 of the corresponding cartridge 20 in a state where the drawer 10 is in the first position.

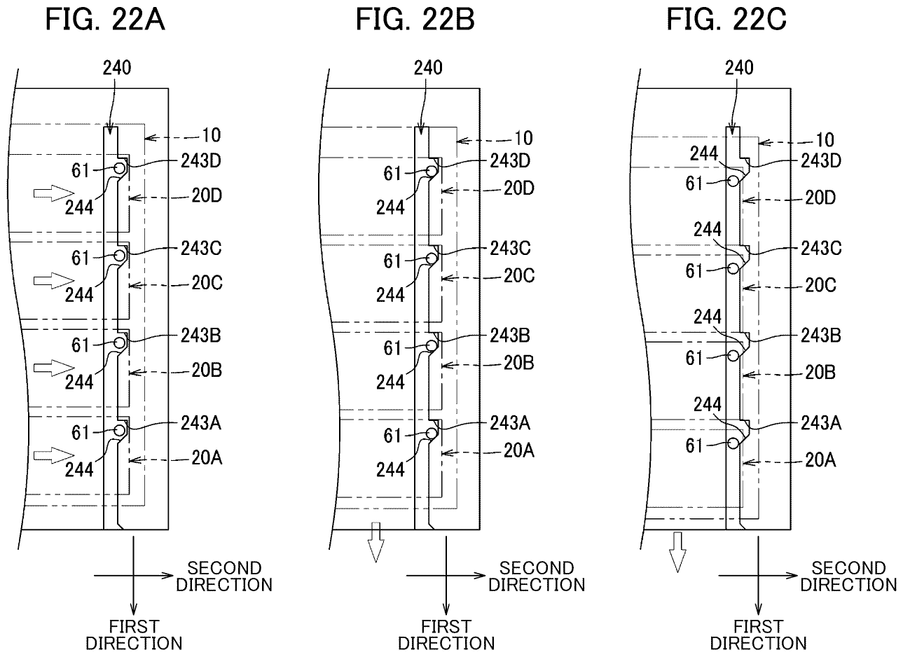

As illustrated in FIG. 22A, the boss 61 enters the corresponding recess 243 as the cartridge 20 is pressed by the corresponding drum joint 93 and developing joint 94 to be moved toward the one side in the second direction. Specifically, the boss 61 of the first cartridge 20A enters the first recess 243A, and the boss 61 of the second cartridge 20B enters the second recess 243B.

Further, the boss 61 of the third cartridge 20C enters the third recess 243C, and the boss 61 of the fourth cartridge 20D enters the fourth recess 243D. As a result, in each of the first through fourth cartridges 20A through 20D, the first electrodes 40 contact the corresponding first main-body electrodes 250, and the memory electrodes 71 contact the corresponding relay electrodes 160.

Each of the recesses 243 has a second inclined surface 244. The second inclined surface 244 is positioned at one end portion of the recess 243 in the first direction. The second inclined surface 244 is inclined so as to be farther from the one end portion of the main housing 2 in the second direction as the second inclined surface 244 extends toward the one end in the first direction from the other end in the first direction. In other words, the second inclined surface 244 is inclined so as to be farther from the one end portion of the main housing 2 in the second direction as the second inclined surface 244 extends toward the one end portion of the recess 243 in the first direction. The second inclined surface 244 is an example of the “inclined surface of the recess”.

During the movement of the drawer 10 from the first position to the second position, the boss 61 contacts the second inclined surface 244 of the corresponding recess 243, as illustrated in FIG. 22B. Subsequently, as the drawer 10 continues to be moved toward the second position as illustrated in FIG. 22C, the boss 61 is moved in the direction away from the one end portion of the main housing 2 in the second direction while moving along the second inclined surface 244 toward the one end portion of the main housing 2 in the first direction from the other end portion of the main housing 2 in the first direction. As a result, each of the first through fourth cartridges 20A through 20D is moved in the direction away from the one end portion of the main housing 2 in the second direction.

The presence of each of the recesses 243 of the guide groove 240 enables the cartridge 20 to be moved toward the one end portion of the main housing 2 in the second direction in a state where the drawer 10 to which the cartridge 20 is attached is in the first position, regardless of the fact that the boss 61 does not move relative to the cartridge frame 30.

Since the recesses 243 include the first recess 243A, the second recess 243B, the third recess 243C, and the fourth recess 243D, the first through fourth cartridges 20A through 20D are movable in the direction toward the one end portion of the main housing 2 in the second direction in a state where the drawer 10 to which the first through fourth cartridges 20A through 20D are attached is in the first position.

Each of the recesses 243 has the second inclined surface 244. This configuration enables the cartridge 20 to be moved in the direction away from the one end portion of the main housing 2 in the second direction when the drawer 10 is moved from the first position to the second position, thereby inhibiting contact of the first electrodes 40 of the cartridge 20 with the main housing 2 during the movement of the drawer 10 from the first position to the second position.

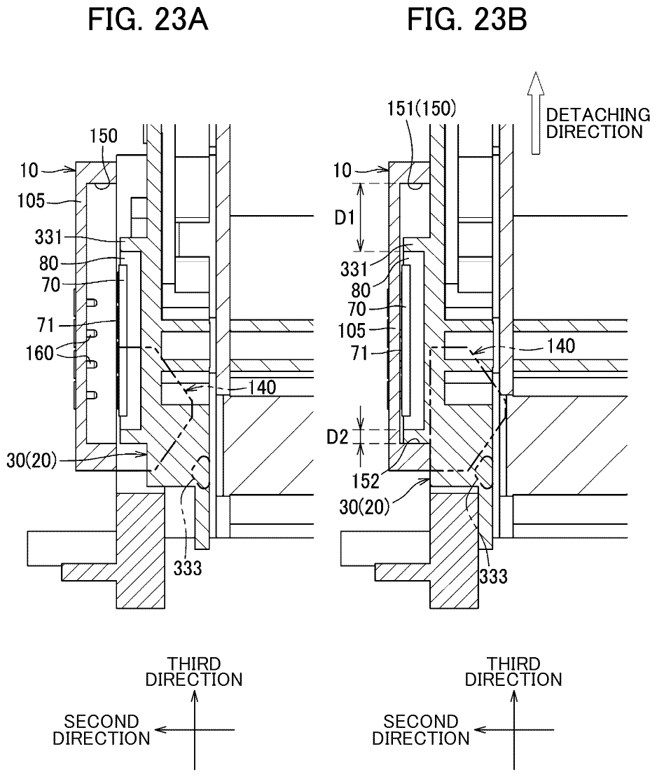

Next, a second modification will be described. As illustrated in FIG. 23A, the cartridge memory 70 of each of the cartridges 20 does not move relative to the cartridge frame 30. Specifically, the memory holder 80 that holds the cartridge memory 70 is held by the holding portion 331 of the cartridge frame 30 while the memory holder 80 is fixed to the holding portion 331. The memory holder 80 protrudes toward the one side in the second direction together with the holding portion 331.

As illustrated in FIG. 23B, each of the recesses 150 in the fifth drawer wall 105 is configured to receive the cartridge memory 70 of the corresponding cartridge 20 in a state where the cartridge 20 is attached to the drawer 10. Specifically, the memory holder 80 enters the corresponding recess 150 together with the cartridge memory 70 in a state where the cartridge 20 is attached to the drawer 10.

The cartridge 20 is pressed by the corresponding drum joint 93 and developing joint 94 to be moved in the direction toward the one end portion of the main housing 2 in the second direction from the other end portion of the main housing 2 in the second direction, whereby the cartridge memory 70 and the memory holder 80 enter the corresponding recess 150. At this time, the first electrodes 40 of the cartridge 20 contact the corresponding first main-body electrodes 250 (see FIG. 14), and the memory electrodes 71 of the cartridge 20 contact the corresponding relay electrodes 160.

In a state where the cartridge 20 is attached to the drawer 10, a distance D1 in the detaching direction of the cartridge 20 between the memory holder 80 and a first surface 151 of the recess 150 is greater than a distance D2 in the detaching direction of the cartridge 20 between the memory holder 80 and a second surface 152 of the recess 150. The first surface 151 is a surface positioned at one end of the inner surface of the recess 150 in the third direction. In other words, the first surface 151 is a surface positioned at a downstream end in the detaching direction of the cartridge 20 on the inner surface of the recess 150.

The second surface 152 is a surface positioned at the other end of the inner surface of the recess 150 in the third direction. In other words, the second surface 152 is a surface positioned at an upstream end in the detaching direction of the cartridge 20 on the inner surface of the recess 150. In the second modification, the holding portion 331 also enters the recess 150. The holding portion 331 is in contact with the second surface 152 in a state where the holding portion 331 enters the recess 150. Alternatively, the holding portion 331 may be separated from the second surface 152 in a state where the holding portion 331 enters the recess 150.

Since the distance D1 between the memory holder 80 and the first surface 151 is greater than the distance D2 between the memory holder 80 and the second surface 152, interference between the memory holder 80 and the inner surfaces of the recess 150 can be inhibited during the detachment of the cartridge 20 from the drawer 10.

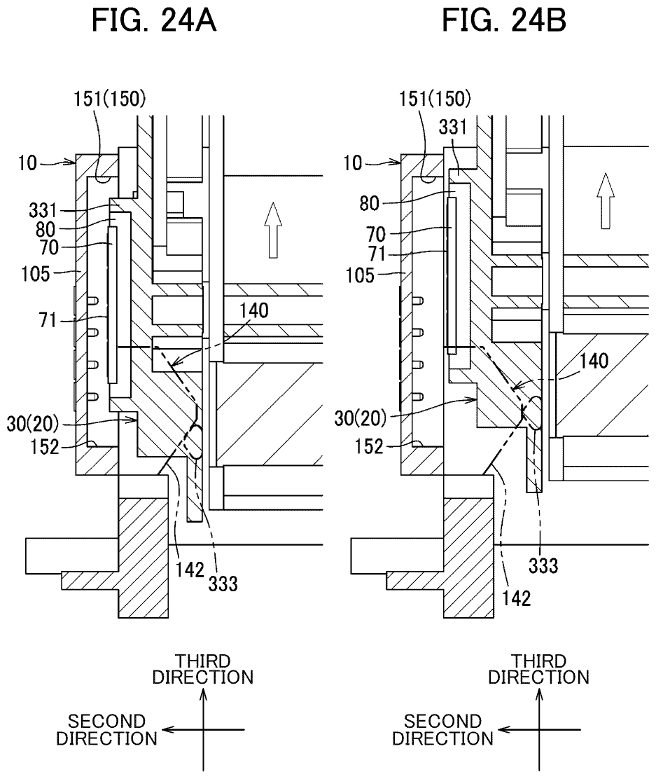

Specifically, when the cartridge 20 is detached from the drawer 10, the protrusion 333 is moved along the second guide inclined surface 142, thereby moving the cartridge 20 from the other side in the third direction toward the one side in the third direction and from the one side in the second direction toward the other side in the second direction, as illustrated in FIGS. 24A and 24B. At this time, interference between the memory holder 80 and the first surface 151 of the recess 150 can be restricted since the distance D1 between the memory holder 80 and the first surface 151 is large.

Also, the fifth drawer wall 105 includes the recesses 150 each configured to receive the cartridge memory 70 of the corresponding cartridge 20, thereby protecting both the cartridge memory 70 and the memory electrodes 71 of the cartridge 20.

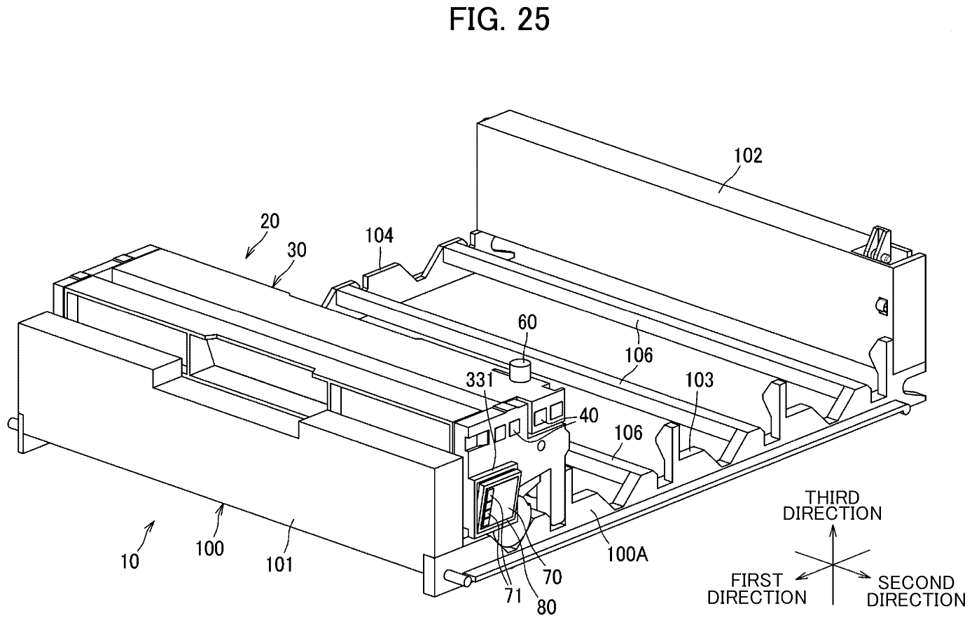

Next, a third modification will be described. As illustrated in FIG. 25, the drawer 10 includes the drawer frame 100 including the first drawer wall 101, the second drawer wall 102, the third drawer wall 103, the fourth drawer wall 104, and the four beams 106. In other words, the drawer frame 100 in the third modification does not include the fifth drawer wall 105 (see FIG. 9).

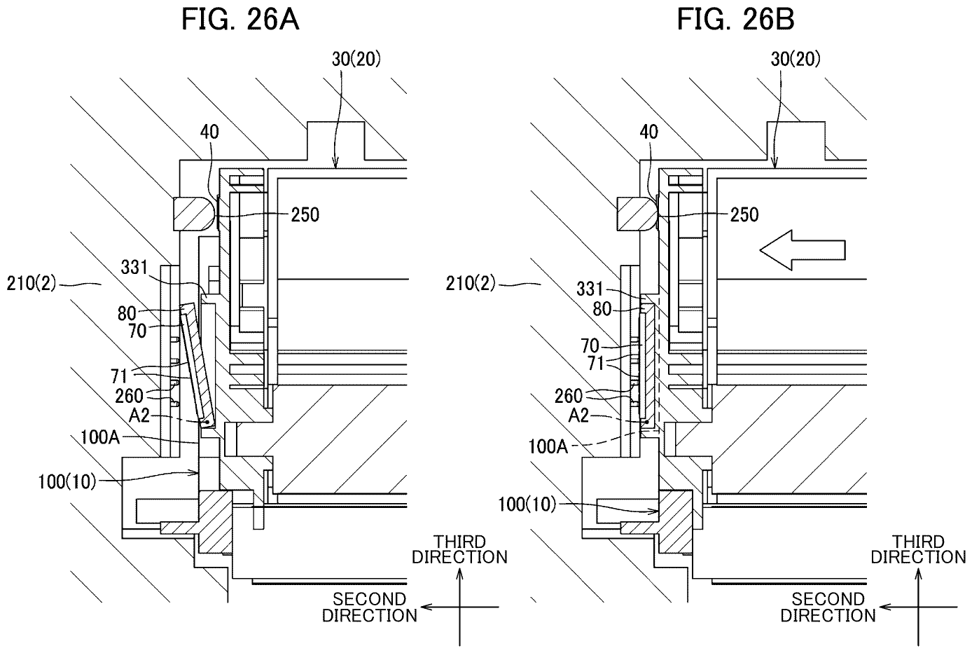

As illustrated in FIG. 26A, the main housing 2 includes the first main wall 210, the first main-body electrodes 250, and the second main-body electrodes 260. The first main wall 210 opposes the one end portion of the cartridge frame 30 of each of the cartridges 20 in the second direction in a state where the drawer 10 to which the cartridge 20 is attached is in the first position. In each of the cartridges 20, the other end portion of the memory holder 80 in the third direction is pivotably movable about the second axis A2, while the one end portion of the memory holder 80 in the third direction is movable in the second direction. Further, together with the memory holder 80, the cartridge memory 70 is pivotally movable about the second axis A2 between the position illustrated in FIG. 26A and the position illustrated in FIG. 26B. The cartridge memory 70 in the position illustrated in FIG. 26B is positioned closer to the other end portion of the cartridge frame 30 in the second direction than in the position illustrated in FIG. 26A. In this third modification, the first main wall 210 is an example of the “main wall”. The position of the cartridge memory 70 illustrated in FIG. 26A is an example of the “third position”. The position of the cartridge memory 70 illustrated in FIG. 26B is an example of the “fourth position”.

The memory electrodes 71 are positioned closer in the second direction to the first main wall 210 than a first end face 100A, which is one end portion of the drawer frame 100 in the second direction, is to the first main wall 210. Specifically, in a state where the drawer 10 to which the cartridge 20 is attached is in the first position and at least one end portion of the cartridge memory 70 in the third direction has been moved to a position farther away from the other end portion of the cartridge frame 30 in the second direction, i.e., the cartridge memory 70 is in the position illustrated in FIG. 26A, the memory electrodes 71 are positioned closer in the second direction to the one end portion of the main housing 2 in the second direction than the first end face 100A is to the one end portion of the main housing 2 in the second direction. The first end face 100A is an example of the “one end portion of the drawer frame 100 in the second direction”.

As illustrated in FIG. 26B, the cartridge 20 is pressed by the corresponding drum joint 93 and developing joint 94 to be moved in the direction toward the one end portion of the main housing 2 in the second direction from the other end portion of the main housing 2 in the second direction. As a result, the first electrodes 40 contact the corresponding first main-body electrodes 250, and the memory electrodes 71 directly contact the corresponding second main-body electrodes 260. At this time, the one end portion of the memory holder 80 in the third direction and the one end portion of the cartridge memory 70 in the third direction are moved toward the other side in the second direction about the second axis A2.

In the third modification, the memory electrodes 71 are positioned closer in the second direction to the one end portion of the main housing 2 in the second direction than the first end face 100A is to the one end portion of the main housing 2 in the second direction also in a state where the drawer 10 to which the cartridge 20 is attached is in the first position and at least the one end portion of the cartridge memory 70 in the third direction has been moved to a position close to the other end portion of the cartridge frame 30 in the second direction (i.e., the cartridge memory 70 is in the position illustrated in FIG. 26B).

Since the memory electrodes 71 are positioned closer in the second direction to the first main wall 210 than the first end face 100A of the drawer frame 100 is to the first main wall 210, the memory electrodes 71 are enabled to be directly connected to the electrodes of the main housing 2. In other words, since the memory electrodes 71 are positioned closer in the second direction to the one end portion of the main housing 2 in the second direction than the first end face 100A of the drawer frame 100 is to the one end portion of the main housing 2 in the second direction, the memory electrodes 71 are enabled to be directly connected to the electrodes of the main housing 2. Specifically, the memory electrodes 71 can be directly connected to the corresponding second main-body electrodes 260.

Further, also in the third modification, each of the cartridges 20 includes the resilient member 85 (see FIGS. 6A and 6B) that urges the memory holder 80. This configuration enables the memory electrodes 71 of the cartridge memory 70 to be pressed against the corresponding second main-body electrodes 260, which are the electrodes in the main housing 2, using the urging force of the resilient member 85.

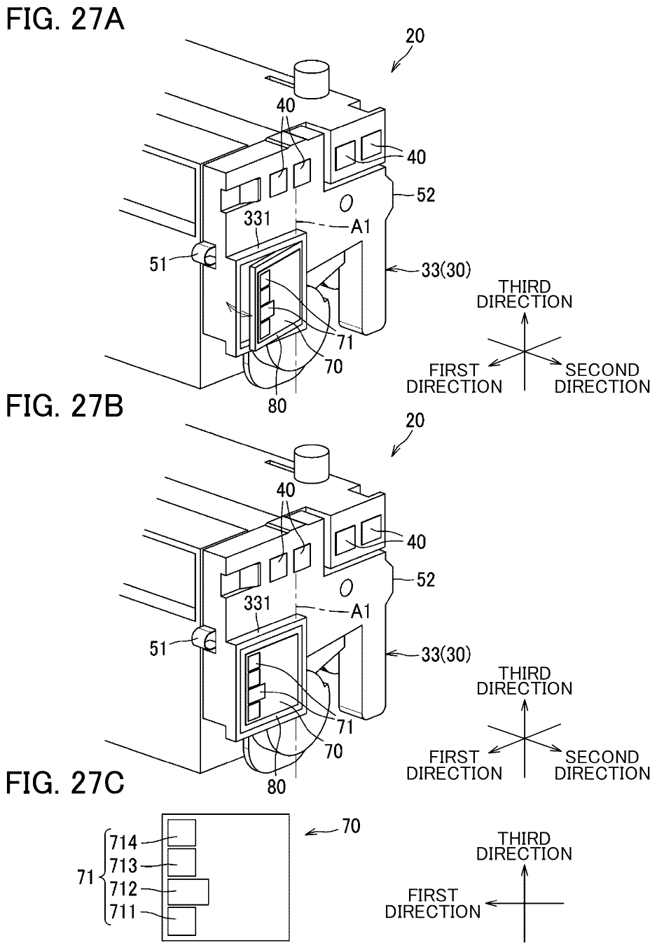

Next, a fourth modification will be described. As illustrated in FIGS. 27A and 27B, the memory holder 80 is pivotally movable about a first axis A1 extending in the third direction relative to the holding portion 331 of the cartridge frame 30. The first axis A1 is positioned at the other end portion of the memory holder 80 in the first direction. The other end portion of the memory holder 80 in the first direction is pivotally movable about the first axis A1, while one end portion of the memory holder 80 in the first direction is movable in the second direction. In this fourth modification, the first axis A1 is an example of the “pivot axis”.

As illustrated in FIG. 27C, the second memory electrode 712 in this modification has a length in the first direction that is the largest among the first memory electrode 711, the second memory electrode 712, the third memory electrode 713, and the fourth memory electrode 714 of the memory electrodes 71. The first memory electrode 711, the third memory electrode 713, and the fourth memory electrode 714 have lengths the same as one another in the first direction. Further, the first memory electrode 711, the second memory electrode 712, the third memory electrode 713, and the fourth memory electrode 714 have lengths the same as one another in the third direction.

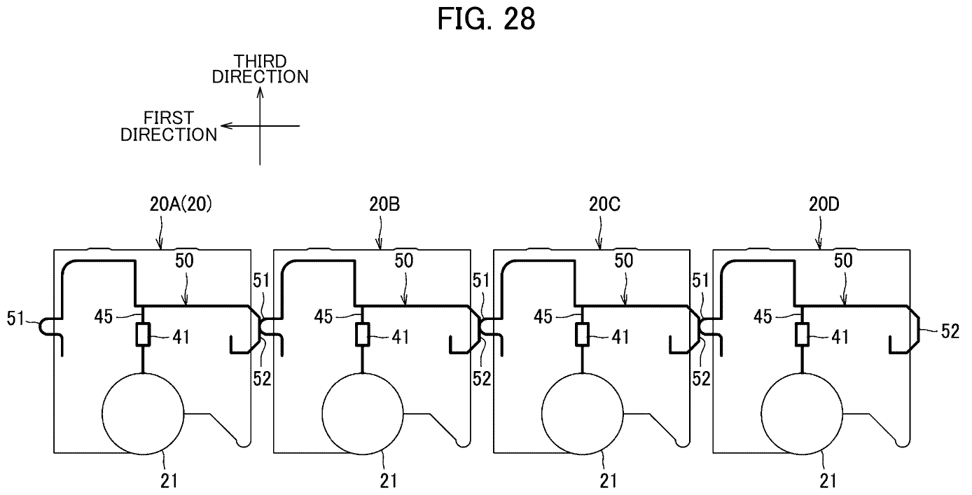

Next, a fifth modification will be described. As illustrated in FIG. 28, the drum electrode 41, the second electrode 51, and the third electrode 52 are electrically connected to one another. Specifically, the drum electrode 41 is electrically connected to the cartridge electrode 50 via a conductive portion 45. The drum electrode 41 may be integrally formed with the cartridge electrode 50 as a part of the cartridge electrode 50. In this fifth modification, the drum electrode 41 is an example of the “first electrode”.

Since the drum electrode 41, the second electrode 51, and the third electrode 52 are electrically connected to one another, an electrical connection can be secured from end portions of the cartridge 20 in the first direction and one end portion of the cartridge 20 in the second direction. Specifically, the electrical connection can be secured from the one end portion of the cartridge 20 in the first direction, the other end portion of the cartridge 20 in the first direction, and the one end portion of the cartridge 20 in the second direction.

Also, the above configuration enables the cartridges 20 arranged in the first direction to be electrically connected to one another. For example, even if the electrical connection between the drum electrode 41 in one cartridge 20 and the corresponding electrode in the main housing 2 is interrupted due to foreign objects being trapped, the electrical connection can still be maintained through other cartridges 20 arranged in the first direction.

Next, other modifications will be described. In the above embodiment, the first electrodes 40 are configured to contact the corresponding first main-body electrodes 250. However, for example, the first electrodes 40 may be configured to be electrically connected to the corresponding electrodes in the main housing 2 through electrodes in the drawer 10.

In the configuration in which the first electrodes 40 are electrically connected to the corresponding electrodes in the main housing 2 through the electrodes in the drawer 10, each of the cartridges 20 may include the boss 60 configured to be guided by the main housing 2. This configuration can inhibit significant movement of the cartridge 20 in the second direction when the drawer 10 is moved to the first position from the second position. Specifically, since the cartridge 20 includes the boss 60 and the main housing 2 includes the guide groove 240 configured to guide the boss 60, significant movement of the cartridge 20 in the second direction can be inhibited during the movement of the drawer 10 to the first position from the second position, thereby restricting the first electrodes 40 from contacting the drawer 10.

Further, in the configuration in which the first electrodes 40 are electrically connected to the corresponding electrodes in the main housing 2 through the electrodes in the drawer 10, the urging force of the resilient member 65 may be greater than the frictional force generated between the cartridge 20 and the drawer 10 when the cartridge 20 is moved in the second direction. With this configuration, the cartridge 20 is moved in the direction in which the first electrodes 40 are separated from the drawer 10 in the second direction when the drawer 10 is moved to the first position from the second position.

Further, in the configuration in which the first electrodes 40 are electrically connected to the corresponding electrodes in the main housing 2 through the electrodes in the drawer 10, the drawer 10 may include the cartridge guides 140. This configuration can inhibit the first electrodes 40, which are the electrodes in the cartridge 20, from contacting the drawer 10 during the attachment of the cartridge 20 to the drawer 10. In other words, the first electrodes 40, which are the electrodes positioned at the one end portion of the cartridge frame 30 in the second direction, can be restricted from contacting the drawer 10 during the attachment of the cartridge 20 to the drawer 10.

Further, in the configuration in which the first electrodes 40 are electrically connected to the corresponding electrodes in the main housing 2 through the electrodes in the drawer 10, the developing electrode 43 may protrude further in the second direction than the drum electrode 41 does. This configuration reduces a protruding amount by which the electrode in the drawer 10, that is configured to be electrically connected to the developing electrode 43, protrudes in the second direction.

Further, in the configuration in which the first electrodes 40 are electrically connected to the corresponding electrodes in the main housing 2 through the electrodes in the drawer 10 and the developing frame 32 is pivotally movable relative to the drum frame 31, the length L43 of the developing electrode 43 in the first direction may be greater than the length L41 of the drum electrode 41 in the first direction. This configuration ensures the contact between the developing electrode 43 and the corresponding electrode in the drawer 10 regardless of the pivotal movement of the developing frame 32.

In the above embodiment, the boss 60 is positioned at the one end portion of the developing frame 32 in the third direction. However, for example, the boss may be positioned at one end portion of the drum frame in the third direction. Alternatively, for example, the boss may be positioned at one end portion of the first side cover in the third direction.

In the above embodiment, the drawer 10 includes the two pressing projections 130 (i.e., the first pressing projection 131 and the second pressing projection 132). However, for example, the drawer may include three or more pressing projections, or may include only one pressing projection. Alternatively, the drawer may not include any pressing projection.

In the above embodiment, the memory holder 80 is pivotally movable about the second axis A2 positioned at the other end portion of the memory holder 80 in the third direction. However, the memory holder may be pivotally movable about a second axis positioned at the one end portion of the memory holder in the third direction, for example.

In the fourth modification, the memory holder 80 is pivotally movable about the first axis A1 positioned at the other end portion of the memory holder 80 in the first direction. However, the memory holder may be pivotally movable about a first axis positioned at the one end portion of the memory holder in the first direction, for example.

Although the memory holder 80 is pivotally movable in the above embodiment, the memory holder may be linearly movable in the second direction.

In the above embodiment, the second electrode 51 and the third electrode 52 are electrically connected to each other. However, for example, the second electrode and the third electrode may be electrodes that are independent of each other and are not electrically connected to each other. The first electrode and the second electrode may be electrically connected to each other, while the third electrode may be an independent electrode that is not electrically connected to either the first electrode or the second electrode. Alternatively, the first electrode and the third electrode may be electrically connected to each other, while the second electrode may be an independent electrode that is not electrically connected to either the first electrode or the third electrode. Still alternatively, the first electrode, the second electrode, and the third electrode may be electrodes that are independent of one another and are not electrically connected to one another.

In the above embodiment, each of the cartridges 20 includes the second electrode 51 and the third electrode 52. However, the cartridge may not include either the second electrode or the third electrode.

In the above embodiment, the image forming apparatus 1 is a color laser printer. However, the image forming apparatus may be a monochromatic laser printer, for example. Alternatively, the image forming apparatus may be an LED printer. Still alternatively, the image forming apparatus may be a copying machine or a multifunction peripheral.

The elements described in the above embodiment and modifications may be implemented in any combination.

The present disclosure encompasses the following aspects.
(Aspect 1) The disclosure provides a cartridge attachable to and detachable from a drawer movable in a first direction relative to a main housing of an image forming apparatus between a first position in which the drawer is accommodated in the main housing and a second position in which at least a part of the drawer is positioned outside the main housing. The cartridge includes: a photosensitive drum; a developing roller; a cartridge frame; a first electrode; a second electrode; a third electrode; and a boss. The photosensitive drum includes a drum shaft extending in a second direction crossing the first direction. The developing roller includes a developing shaft extending in the second direction. The cartridge frame supports both the photosensitive drum and the developing roller. The first electrode is positioned at one end portion of the cartridge frame in the second direction. The second electrode is positioned at one end portion of the cartridge frame in the first direction. The third electrode is positioned at an other end portion of the cartridge frame in the first direction. The boss is positioned at one end portion of the cartridge frame in a third direction crossing both the first direction and the second direction. The boss protrudes in the third direction. The boss is configured to be guided by the main housing when the drawer to which the cartridge is attached is moved toward the first position from the second position.
With the cartridge according to aspect 1, the cartridge includes the boss configured to be guided by the main housing. The presence of the boss can inhibit significant movement of the cartridge in the second direction when the drawer to which the cartridge is attached is moved to the first position from the second position, thereby restricting contact of the first electrode, which is the electrode of the cartridge, with the drawer or the main housing.
(Aspect 2) In the cartridge according to aspect 1, the boss is movable in the second direction relative to the cartridge frame.
(Aspect 3) The cartridge according to aspect 2 further includes a resilient member. The resilient member urges the boss in a direction toward the first electrode in the second direction. The boss is movable in a direction away from the first electrode in the second direction against an urging force of the resilient member.
(Aspect 4) In the cartridge according to aspect 3, the urging force of the resilient member is greater than a frictional force generated between the cartridge and the drawer when the cartridge is moved in the second direction relative to the drawer.
(Aspect 5) In the cartridge according to aspect 1, the cartridge frame includes: a drum frame; and a developing frame. The drum frame supports the photosensitive drum. The developing frame supports the developing roller. The boss is positioned at one end portion of the developing frame in the third direction.
(Aspect 6) In the cartridge according to aspect 1, the boss has a columnar shape. A protruding amount by which the boss protrudes in the third direction is greater than a radius of the boss.
(Aspect 7) In the cartridge according to aspect 1, the second electrode and the third electrode are electrically connected to each other.
(Aspect 8) In the cartridge according to aspect 1, the first electrode, the second electrode, and the third electrode are electrically connected to one another.
(Aspect 9) The disclosure also provides an image forming apparatus including: a main housing; a drawer; and a cartridge. The drawer is movable in a first direction relative to the main housing between: a first position in which the drawer is accommodated in the main housing; and a second position in which at least a part of the drawer is positioned outside the main housing. The cartridge is attachable to and detachable from the drawer. The cartridge includes: a photosensitive drum; a developing roller; a cartridge frame; a first electrode; a second electrode; a third electrode; and a boss. The photosensitive drum includes a drum shaft extending in a second direction crossing the first direction. The developing roller includes a developing shaft extending in the second direction. The cartridge frame supports both the photosensitive drum and the developing roller. The first electrode is positioned at one end portion of the cartridge frame in the second direction. The second electrode is positioned at one end portion of the cartridge frame in the first direction. The third electrode is positioned at an other end portion of the cartridge frame in the first direction. The boss is positioned at one end portion of the cartridge frame in a third direction crossing both the first direction and the second direction. The boss protrudes in the third direction. The main housing has a guide groove. The guide groove extends in the first direction. The guide groove is configured to guide the boss when the drawer to which the cartridge is attached is moved toward the first position from the second position.
With the image forming apparatus according to aspect 9, since the cartridge includes the boss and the main housing has the guide groove configured to guide the boss, the cartridge can be restricted from moving significantly in the second direction when the drawer to which the cartridge is attached is moved to the first position from the second position. Accordingly, the first electrode, which is the electrode of the cartridge, can be restricted from contacting the drawer or the main housing.
(Aspect 10) In the image forming apparatus according to aspect 9, the guide groove has: an opening portion; and an inclined surface. The opening portion is positioned at one end portion of the guide groove in the first direction. The opening portion is configured to receive the boss into the guide groove. The inclined surface defines one end portion of the opening portion in the second direction. The inclined surface is inclined so that a width of the opening portion in the second direction increases as the inclined surface extends toward the one end portion of the guide groove in the first direction.
(Aspect 11) In the image forming apparatus according to aspect 9, the guide groove has a recess. The recess is recessed toward one end portion of the main housing in the second direction. The recess is configured to receive the boss in a state where the drawer to which the cartridge is attached is in the first position.
(Aspect 12) In the image forming apparatus according to aspect 11, the cartridge further includes: a drum coupling; and a developing coupling. The drum coupling is positioned at an other end portion of the cartridge frame in the second direction. The drum coupling is configured to transmit a drive force to the photosensitive drum. The developing coupling is positioned at the other end portion of the cartridge frame in the second direction. The developing coupling is configured to transmit a drive force to the developing roller. The image forming apparatus further includes: a drum joint; a developing joint; and a main-body electrode. The drum joint is movable from an other end portion of the main housing in the second direction toward the one end portion of the main housing in the second direction to be coupled to the drum coupling. The drum joint is configured to transmit the drive force to the photosensitive drum through the drum coupling. The developing joint is movable from the other end portion of the main housing in the second direction toward the one end portion of the main housing in the second direction to be coupled to the developing coupling. The developing joint is configured to transmit the drive force to the developing roller through the developing coupling. The main-body electrode is positioned at the one end portion of the main housing in the second direction. The main-body electrode is configured to contact the first electrode. In a state where the drawer to which the cartridge is attached is in the first position, the drum joint and the developing joint press and move the cartridge toward the one end portion of the main housing in the second direction to cause the first electrode to contact the main-body electrode.
(Aspect 13) In the image forming apparatus according to aspect 11, the recess has an inclined surface. The inclined surface is positioned at one end portion of the recess in the first direction. The inclined surface is inclined so as to be farther from the one end portion of the main housing in the second direction as the inclined surface extends toward the one end portion of the recess in the first direction.
(Aspect 14) The image forming apparatus according to aspect 11 further includes a second cartridge. The second cartridge is attachable to and detachable from the drawer. The second cartridge includes: a second cartridge frame; and a second boss. The second boss is positioned at one end portion of the second cartridge frame in the third direction. The second boss protrudes in the third direction. In a state where both the cartridge and the second cartridge are attached to the drawer, the cartridge and the second cartridge are arranged in the first direction. The guide groove is also configured to guide the second boss when the drawer to which the second cartridge is attached is moved toward the first position from the second position. The guide groove further has a second recess recessed toward the one end portion of the main housing in the second direction. The second recess is configured to receive the second boss in a state where the drawer to which the second cartridge is attached is in the first position.
(Aspect 15) The disclosure also provides an image forming apparatus including: a main housing; a drawer; and a cartridge. The drawer is movable in a first direction relative to the main housing between: a first position in which the drawer is accommodated in the main housing; and a second position in which at least a part of the drawer is positioned outside the main housing. The cartridge is attachable to and detachable from the drawer. The cartridge includes: a photosensitive drum; a developing roller; a cartridge frame; a first electrode; a second electrode; and a third electrode. The photosensitive drum includes a drum shaft extending in a second direction crossing the first direction. The developing roller includes a developing shaft extending in the second direction. The cartridge frame supports both the photosensitive drum and the developing roller. The first electrode is positioned at one end portion of the cartridge frame in the second direction. The second electrode is positioned at one end portion of the cartridge frame in the first direction. The third electrode is positioned at an other end portion of the cartridge frame in the first direction. The drawer includes a cartridge guide. The cartridge guide is configured to guide the cartridge to cause the cartridge to move in a direction away from one end portion of the drawer in the second direction during attachment of the cartridge to the drawer.
With the image forming apparatus according to aspect 15, the drawer includes the cartridge guide, thereby restricting the side surface of the cartridge from contacting the drawer during the attachment of the cartridge to the drawer.
(Aspect 16) In the image forming apparatus according to aspect 15, the cartridge guide has a guide inclined surface inclined so as to be farther from the one end portion of the drawer in the second direction as the guide inclined surface extends in an attaching direction in which the cartridge is attached to the drawer. The guide inclined surface is configured to guide the cartridge during the attachment of the cartridge to the drawer.
(Aspect 17) In the image forming apparatus according to aspect 15, the cartridge guide has a guide inclined surface. The guide inclined surface is inclined so as to be farther from the one end portion of the drawer in the second direction as the guide inclined surface extends in a detaching direction in which the cartridge is detached from the drawer. The guide inclined surface is configured to guide the cartridge during detachment of the cartridge from the drawer.
(Aspect 18) In the image forming apparatus according to aspect 15, in a state where the cartridge is attached to the drawer, the cartridge guide overlaps the third electrode in position in the first direction and overlaps the third electrode in position in the second direction.
(Aspect 19) In the image forming apparatus according to aspect 15, the cartridge frame includes a protrusion. The protrusion protrudes in the first direction. The protrusion is configured to be guided by the cartridge guide.
(Aspect 20) In the image forming apparatus according to aspect 19, the protrusion overlaps the third electrode in position in the first direction and overlaps the third electrode in position in the second direction.
(Aspect 21) In the image forming apparatus according to aspect 17, the cartridge further includes a cartridge memory. The cartridge memory is positioned at the one end portion of the cartridge frame in the second direction. The cartridge memory includes a memory electrode. The memory electrode faces in the second direction. The drawer includes: a drawer frame; and a drawer electrode. The drawer frame includes a drawer wall having a recess. The drawer electrode is positioned in the recess. In a state where the cartridge is attached to the drawer, the drawer wall opposes the one end portion of the cartridge frame in the second direction, the cartridge memory is received in the recess, and the drawer electrode is electrically connected to the memory electrode.
(Aspect 22) In the image forming apparatus according to aspect 21, the cartridge further includes a memory holder. The memory holder holds the cartridge memory. The memory holder protrudes in the second direction. The memory holder is received in the recess in a state where the cartridge is attached to the drawer.
(Aspect 23) In the image forming apparatus according to aspect 22, the recess has: a first surface; and a second surface. The first surface is positioned at a downstream end of the recess in the detaching direction. The second surface is positioned at an upstream end of the recess in the detaching direction. In a state where the cartridge is attached to the drawer, a distance in the detaching direction between the memory holder and the first surface is greater than a distance in the detaching direction between the memory holder and the second surface.
(Aspect 24) In the image forming apparatus according to aspect 15, the cartridge further includes a cartridge memory. The cartridge memory is positioned at the one end portion of the cartridge frame in the second direction. The cartridge memory includes a memory electrode. The memory electrode faces in the second direction. The main housing includes a main wall. The drawer includes a drawer frame. In a state where the drawer to which the cartridge is attached is in the first position, the main wall opposes the one end portion of the cartridge frame in the second direction, the drawer frame supports the cartridge, and the memory electrode is positioned closer in the second direction to the main wall than one end portion of the drawer frame in the second direction is to the main wall.
(Aspect 25) In the image forming apparatus according to aspect 15, the drawer includes: a drawer frame; and a pressing projection. The drawer frame has one end portion and an other end portion in the second direction. The pressing projection is positioned at the other end portion of the drawer frame in the second direction. The pressing projection protrudes in the second direction. The pressing projection is in contact with the main housing and urges the drawer toward one end portion of the main housing in the second direction in a state where the drawer is in the first position.
(Aspect 26) In the image forming apparatus according to aspect 25, the drawer frame has one end portion and an other end portion in the first direction. The pressing projection is positioned at the other end portion of the drawer frame in the first direction.
(Aspect 27) The image forming apparatus according to aspect 26 further includes: a drum joint; and a developing joint. The drum joint is positioned at an other end portion of the main housing in the second direction. The drum joint is configured to transmit a drive force to the photosensitive drum. The developing joint is positioned at the other end portion of the main housing in the second direction. The developing joint is configured to transmit a drive force to the developing roller. The pressing projection is positioned between the drum joint and the developing joint in a third direction crossing both the first direction and the second direction.
(Aspect 28) The image forming apparatus according to aspect 27 further includes a second pressing projection. The second pressing projection is positioned at the other end portion of the drawer frame in the second direction. The second pressing projection protrudes in the second direction. The second pressing projection is in contact with the main housing and urges the drawer toward the one end portion of the main housing in the second direction in a state where the drawer is in the first position. The second pressing projection is positioned closer in the third direction to one end portion of the drawer frame in the third direction than both the drum joint and the developing joint are to the one end portion of the drawer frame in the third direction.
(Aspect 29) In the image forming apparatus according to aspect 25, the main housing includes a first main wall and a second main wall. In a state where the drawer is in the first position, the first main wall opposes the one end portion of the drawer frame in the second direction, the second main wall opposes the other end portion of the drawer frame in the second direction, and the pressing projection is in contact with the second main wall.
(Aspect 30) In the image forming apparatus according to aspect 15, the second electrode and the third electrode are electrically connected to each other.
(Aspect 31) In the image forming apparatus according to aspect 15, the first electrode, the second electrode, and the third electrode are electrically connected to one another.

What is claimed is:

1. A cartridge attachable to and detachable from a drawer movable in a first direction relative to a main housing of an image forming apparatus between a first position in which the drawer is accommodated in the main housing and a second position in which at least a part of the drawer is positioned outside the main housing, the cartridge comprising:
a photosensitive drum including a drum shaft extending in a second direction crossing the first direction;
a developing roller including a developing shaft extending in the second direction;
a cartridge frame supporting both the photosensitive drum and the developing roller;
a first electrode positioned at one end portion of the cartridge frame in the second direction;
a second electrode positioned at one end portion of the cartridge frame in the first direction;
a third electrode positioned at an other end portion of the cartridge frame in the first direction; and
a cartridge memory positioned at the one end portion of the cartridge frame in the second direction, the cartridge memory being movable in the second direction relative to the cartridge frame, the cartridge memory including:
a memory electrode facing in the second direction.

2. The cartridge according to claim 1,
wherein the cartridge memory is movable in the second direction relative to the cartridge frame between a third position and a fourth position, the cartridge memory in the fourth position being closer to an other end portion of the cartridge frame in the second direction than in the third position,
wherein the cartridge is supported by a drawer frame of the drawer in a state where the cartridge is attached to the drawer, and
wherein, in a state where the drawer to which the cartridge is attached is in the first position and the cartridge memory is in the third position, the memory electrode is positioned closer in the second direction to one end portion of the main housing in the second direction than one end portion of the drawer frame in the second direction is to the one end portion of the main housing in the second direction.

3. The cartridge according to claim 1, further comprising:
a memory holder holding the cartridge memory, the memory holder being movable in the second direction relative to the cartridge frame; and
a resilient member urging the memory holder in a direction toward one end portion of the main housing in the second direction in a state where the drawer to which the cartridge is attached is in the first position.

4. The cartridge according to claim 3,
wherein the memory holder is pivotally movable about a pivot axis extending in a third direction crossing both the first direction and the second direction, the pivot axis being positioned at an end portion of the memory holder in the first direction.

5. The cartridge according to claim 3,
wherein the memory holder is pivotally movable about a pivot axis extending in the first direction, the pivot axis being positioned at an end portion of the memory holder in a third direction crossing both the first direction and the second direction.

6. The cartridge according to claim 1,
wherein the memory electrode includes:
a first memory electrode;
a second memory electrode positioned closer to one end portion of the cartridge frame in a third direction than the first memory electrode is to the one end portion of the cartridge frame in the third direction, the third direction crossing both the first direction and the second direction;
a third memory electrode positioned closer to the one end portion of the cartridge frame in the third direction than the second memory electrode is to the one end portion of the cartridge frame in the third direction; and
a fourth memory electrode positioned closer to the one end portion of the cartridge frame in the third direction than the third memory electrode is to the one end portion of the cartridge frame in the third direction, and
wherein the fourth memory electrode has a length in the third direction that is the largest among the first memory electrode, the second memory electrode, the third memory electrode, and the fourth memory electrode.

7. The cartridge according to claim 1,
wherein the memory electrode includes:
a first memory electrode;
a second memory electrode positioned closer to one end portion of the cartridge frame in a third direction than the first memory electrode is to the one end portion of the cartridge frame in the third direction, the third direction crossing both the first direction and the second direction;
a third memory electrode positioned closer to the one end portion of the cartridge frame in the third direction than the second memory electrode is to the one end portion of the cartridge frame in the third direction; and
a fourth memory electrode positioned closer to the one end portion of the cartridge frame in the third direction than the third memory electrode is to the one end portion of the cartridge frame in the third direction, and
wherein the second memory electrode has a length in the first direction that is the largest among the first memory electrode, the second memory electrode, the third memory electrode, and the fourth memory electrode.

8. The cartridge according to claim 1, further comprising:
a memory holder holding the cartridge memory, the memory holder being movable in the second direction relative to the cartridge frame,
wherein the memory holder has a color that corresponds to a color of toner accommodated in the cartridge frame.

9. The cartridge according to claim 1,
wherein the cartridge frame includes:
a drum frame supporting the photosensitive drum;
a developing frame supporting the developing roller, the developing frame being pivotally movable relative to the drum frame between:
a developing position in which the developing roller supplies toner to the photosensitive drum; and
a separation position in which the developing roller is positioned farther away from the photosensitive drum than in the developing position; and
a side cover supporting one end portion of the drum frame in the second direction, the side cover supporting one end portion of the developing frame in the second direction so that the developing frame is pivotally movable.

10. The cartridge according to claim 1,
wherein the cartridge frame includes:
a drum frame supporting the photosensitive drum;
a developing frame supporting the developing roller; and
a side cover supporting one end portion of the drum frame in the second direction, the side cover supporting one end portion of the developing frame in the second direction, the side cover including:
a protruding portion protruding in a third direction crossing both the first direction and the second direction, the protruding portion being received in a recess in the drawer in a state where the cartridge is attached to the drawer.

11. The cartridge according to claim 1,
wherein the cartridge frame includes:
a drum frame supporting the photosensitive drum;
a developing frame supporting the developing roller; and
a side cover supporting one end portion of the drum frame in the second direction, the side cover supporting one end portion of the developing frame in the second direction, the side cover having:
an inclined surface positioned at one end portion of the side cover in the first direction and at one end portion of the side cover in the second direction, and
wherein, in a state where the cartridge is attached to the drawer, the inclined surface is inclined so as to be farther from one end portion of the drawer in the second direction as the inclined surface extends toward one end portion of the drawer in the first direction, the inclined surface contacting a projection of the main housing when the drawer to which the cartridge is attached is moved toward the second position from the first position.

12. The cartridge according to claim 1,
wherein the cartridge frame includes:
a drum frame supporting the photosensitive drum;
a developing frame supporting the developing roller; and
a side cover supporting one end portion of the drum frame in the second direction, the side cover supporting one end portion of the developing frame in the second direction, and
wherein the first electrode includes:
a drum electrode positioned at the one end portion of the drum frame in the second direction, the drum electrode being electrically connected to the photosensitive drum; and
a developing electrode positioned at the one end portion of the developing frame in the second direction, the developing electrode being electrically connected to the developing roller, the developing electrode protruding further toward one side in the second direction than the drum electrode does.

13. The cartridge according to claim 9,
wherein the first electrode includes:
a drum electrode positioned at the one end portion of the drum frame in the second direction, the drum electrode being electrically connected to the photosensitive drum; and
a developing electrode positioned at the one end portion of the developing frame in the second direction, the developing electrode being electrically connected to the developing roller, the developing electrode having a length in the first direction that is greater than a length of the drum electrode in the first direction.

14. The cartridge according to claim 1,
wherein the second electrode and the third electrode are electrically connected to each other.

15. The cartridge according to claim 1,
wherein the first electrode, the second electrode, and the third electrode are electrically connected to one another.
